(19) United States
(12) Patent Application Publication
(10) Pub. No.: US 2013/0328866 A1
(43) Pub. Date: Dec. 12, 2013

(54) Spatially multiplexed imaging directional backlight displays

(71) Applicant: REALD INC., Beverly Hills, CA (US)

(72) Inventors: Graham J. Woodgate, Henley on Thames (GB); Michael G. Robinson, Boulder, CO (US); Jonathan Harrold, Boulder, CO (US)

(73) Assignee: REALD INC., Beverly Hills, CA (US)

(21) Appl. No.: 13/897,150

(22) Filed: May 17, 2013

Related U.S. Application Data
(63) Continuation-in-part of application No. 13/300,293, filed on Nov. 18, 2011.
(60) Provisional application No. 61/649,149, filed on May 18, 2012.
(60) Provisional application No. 61/415,810, filed on Nov. 19, 2010.

(51) Int. Cl. F21V 8/00; G02B 27/22

(52) U.S. Cl. CPC G02B 6/005; G02B 27/225
USPC 345/419; 362/606; 362/19; 362/607

(57) ABSTRACT

Disclosed is an imaging directional backlight that cooperates with a spatial light modulator to direct light into a first viewing window for one set of image pixels and into a second viewing window for a second set of image pixels. The waveguide may comprise a stepped structure, where the steps further comprise extraction features hidden to guided light, propagating in a first forward direction. Returning light propagating in a second backward direction may be refracted, diffracted, or reflected by the features to provide discrete illumination beams exiting from the top surface of the waveguide. Viewing windows are formed through imaging individual light sources and hence defines the relative positions of system elements and ray paths. Such an apparatus may be used to achieve an autostereoscopic display with a flat structure, not requiring fast response speed spatial light modulators.

### CROSS-REFERENCE TO RELATED APPLICATIONS

This disclosure is a continuation-in-part of U.S. patent application Ser. No. 13/300,293, entitled “Directional Flat Illuminators,” filed Nov. 18, 2011, which claims priority to U.S. Provisional Patent Application No. 61/415,810, entitled “Directional Flat Illuminators,” filed Nov. 19, 2010, the entireties of which are herein incorporated by reference. This application also claims priority to U.S. Provisional Application No. 61/649,149, entitled “Spatially multiplexed imaging directional backlight displays,” filed May 18, 2012, the entirety of which is herein incorporated by reference.

### TECHNICAL FIELD

This disclosure generally relates to illumination of light modulation devices, and more specifically relates to light guides for providing large area illumination from localized light sources for use in 2D, 3D, and/or autostereoscopic display devices.

### BACKGROUND

Spatially multiplexed autostereoscopic displays typically align a parallax component such as a lenticular screen or parallax barrier with an array of images arranged as at least first and second sets of pixels on a spatial light modulator, for example an LCD. The parallax component directs light from each of the sets of pixels into different respective directions to provide first and second viewing windows in front of the display. An observer with an eye placed in the first viewing window can see a first image with light from the first set of pixels; and with an eye placed in the second viewing window can see a second image, with light from the second set of pixels.

Such displays have reduced spatial resolution compared to the native resolution of the spatial light modulator and further, the structure of the viewing windows is determined by the pixel aperture shape and parallax component imaging function. Gaps between the pixels, for example for electrodes, typically produce non-uniform viewing windows. Undesirably such displays exhibit image flicker as an observer moves laterally with respect to the display and so limit the viewing freedom of the display. Such flicker can be reduced by defocusing the optical elements; however such defocusing results in increased levels of image cross talk and increases visual strain for an observer. Such flicker can be reduced by adjusting the shape of the pixel aperture, however such changes can reduce display brightness and can comprise addressing electronics in the spatial light modulator.

### BRIEF SUMMARY

According to the present disclosure, embodiments of a directional illumination apparatus may comprise an array of light emitting elements; a folded imaging directional backlight aligned to the array of light emitting elements; a spatial light modulator comprising first and second groups of pixels; first and second light direction splitting elements aligned with respective first and second groups of pixels; wherein the light direction splitting elements are arranged to direct light from a first part of the array of light emitting elements and folded imaging directional backlight through the first group of pixels to a first viewing window and to substantially direct no light through the second group of pixels to the first viewing window.

The folded imaging directional backlight may comprise an optical valve comprising at least one light extraction element for guiding and extracting light, wherein the at least one light extraction element may comprise a first light guiding surface, wherein the first light guiding surface may be substantially planar; and a second light guiding surface, opposite the first light guiding surface, further comprising a plurality of guiding features and a plurality of extraction features, wherein the extraction features and the guiding features may be connected to and alternate with one another respectively, further wherein the plurality of extraction features may allow light to exit the at least one light extraction element.

The light direction splitting elements may be arranged to direct light from a second part of the array of light emitting elements and folded imaging directional backlight through the second group of pixels to a second viewing window different from the first viewing window. The light direction splitting elements may comprise first and second arrays of polarizer elements with respective different polarization transmission directions and aligned with the first and second groups of pixels. The polarization transmission directions may be orthogonal.

The polarizer elements may comprise a patterned array of retarders and a uniform polarizer. The light emitting elements may be polarized by means of a polarizer array. The polarizer array may be a switchable polarizer. The polarizer array may be a patterned polarizer in alignment with groups of light emitting elements. A switchable polarizer may be arranged between the folded imaging directional backlight and the spatial light modulator. The switchable polarizer may be switched to provide a first polarization output when the first part of the light emitting element array is illuminated, and a second polarization output when the second part of the light emitting element array is illuminated.

The light direction splitting elements may be arranged to direct light from a first part of the array of light emitting elements and folded imaging directional backlight through the second group of pixels to a second viewing window different from the first viewing window. The light direction splitting elements may comprise first and second arrays of light deflection elements with respective different light deflection directions and aligned with the first and second groups of pixels. The light deflection elements may comprise respective first and second prism arrays. The light deflection elements comprise holograms. The folded imaging directional backlight may comprise an optical valve. The folded imaging directional backlight may comprise an optical inline directional backlight. The folded imaging directional backlight may comprise a wedge directional backlight.

Display backlights in general employ waveguides and edge emitting sources. Certain imaging directional backlights have the additional capability of directing the illumination through a display panel into viewing windows. An imaging system may be formed between multiple sources and the respective window images. One example of an imaging directional backlight is an optical valve that may employ a folded optical system and hence may also be an example of a folded imaging directional backlight. Light may propagate substantially without loss in one direction through the optical valve while counter-propagating light may be extracted by reflection off tilted facets as described in patent application Ser. No. 13/300,293, which is herein incorporated by reference, in its entirety.

Directional backlight systems may be arranged with a fast response spatial light modulator and a fast switching array of light emitting elements, arranged so that a first image is presented in the same phase as at least one light emitting element, and a second image is presented for a second light emitting element in a position and phase different from the first light emitting element, with for example a 120 Hz switching frequency. Such an arrangement may achieve substantially flicker free autostereoscopic illumination for a suitably positioned observer. It may be desirable to reduce cost and complexity to provide a slower switching response spatial light modulator, however such a system would have degraded cross talk between the first and second images when viewed by the observer. The present embodiments provide autostereoscopic illumination with a slow switching response spatial light modulator when illuminated by folded imaging directional backlights. Such result is achieved by spatially multiplexing the directionality that is output from a folded imaging directional backlight in registration with image pixels of a spatial light modulator.

Embodiments herein may provide an autostereoscopic display with large area and thin structure. Further, as will be described, the optical valves of the present disclosure may achieve thin optical components with large back working distances. Such components can be used in directional backlights, to provide directional displays including autostereoscopic displays. Further, embodiments may provide a controlled illuminator for the purposes of an efficient autostereoscopic display.

Embodiments of the present disclosure may be used in a variety of optical systems. The embodiments may include or work with a variety of projectors, projection systems, optical components, displays, microdisplays, computer systems, processors, self-contained projector systems, visual and/or audiovisual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

Directional backlights offer control over the illumination emanating from substantially the entire output surface controlled typically through modulation of independent LED light sources arranged at the input aperture side of an optical waveguide. Controlling the emitted light directional distribution can achieve single person viewing for a security function, where the display can only be seen by a single viewer from a limited range of angles; high electrical efficiency, where illumination is only provided over a small angular directional distribution; alternating left and right eye viewing for time sequential stereoscopic and autostereoscopic display; and low cost.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1A is a schematic diagram illustrating a front view of light propagation in one embodiment of a directional display device, in accordance with the present disclosure;

FIG. 1B is a schematic diagram illustrating a side view of light propagation in one embodiment of the directional display device of FIG. 1A, in accordance with the present disclosure;

FIG. 2A is a schematic diagram illustrating in a top view of light propagation in another embodiment of a directional display device, in accordance with the present disclosure;

FIG. 2B is a schematic diagram illustrating light propagation in a front view of the directional display device of FIG. 2A, in accordance with the present disclosure;

FIG. 2C is a schematic diagram illustrating light propagation in a side view of the directional display device of FIG. 2A, in accordance with the present disclosure;

FIG. 3 is a schematic diagram illustrating in a side view of a directional display device, in accordance with the present disclosure;

FIG. 4A is schematic diagram illustrating in a front view, generation of a viewing window in a directional display device and including curved light extraction features, in accordance with the present disclosure;

FIG. 4B is a schematic diagram illustrating in a front view, generation of a first and a second viewing window in a directional display device and including curved light extraction features, in accordance with the present disclosure;

FIG. 5 is a schematic diagram illustrating generation of a first viewing window in a directional display device including linear light extraction features, in accordance with the present disclosure;

FIG. 6A is a schematic diagram illustrating one embodiment of the generation of a first viewing window in a time multiplexed imaging directional display device in a first time slot, in accordance with the present disclosure;

FIG. 6B is a schematic diagram illustrating another embodiment of the generation of a second viewing window in a time multiplexed directional display device in a second time slot, in accordance with the present disclosure;

FIG. 6C is a schematic diagram illustrating another embodiment of the generation of a first and a second viewing window in a time multiplexed directional display device, in accordance with the present disclosure;

FIG. 7 is a schematic diagram illustrating an observer tracking autostereoscopic display apparatus including a time multiplexed directional display device, in accordance with the present disclosure;

FIG. 8 is a schematic diagram illustrating a multi-viewer directional display device;

FIG. 9 is a schematic diagram illustrating a privacy directional display device, in accordance with the present disclosure;

FIG. 10 is a schematic diagram illustrating in side view, the structure of a time multiplexed directional display device, in accordance with the present disclosure;

FIG. 11A is a schematic diagram illustrating a front view of a wedge type directional backlight, in accordance with the present disclosure;

FIG. 11B is a schematic diagram illustrating a side view of a wedge type directional backlight, in accordance with the present disclosure;

FIG. 12 is a schematic diagram illustrating a plan view of an optical inline directional backlight apparatus, in accordance with the present disclosure;

FIG. 13 is a schematic diagram illustrating a directional display apparatus comprising a display device and a control system, in accordance with the present disclosure;

FIG. 14A is a schematic diagram illustrating a plan view of an optical valve apparatus arranged to achieve polarized viewing windows, in accordance with the present disclosure;

FIG. 14B is a schematic diagram illustrating a plan view of an optical valve apparatus arranged to achieve polarized viewing windows, in accordance with the present disclosure;

FIG. 14C is a schematic diagram illustrating a side view of a spatially multiplexed optical valve apparatus, in accordance with the present disclosure;

FIG. 15 is a schematic diagram illustrating a plan view of a spatial light modulator for the spatially multiplexed optical valve apparatus of FIG. 14C, in accordance with the present disclosure;

FIG. 16 is a schematic diagram illustrating a side view of a spatially multiplexed optical valve apparatus, in accordance with the present disclosure;

FIG. 17 is a schematic diagram illustrating a plan view of a spatial light modulator for the spatially multiplexed optical valve apparatus of FIG. 16, in accordance with the present disclosure;

FIG. 18 is a schematic diagram illustrating a plan view of the illumination of an optical valve apparatus, in accordance with the present disclosure;

FIG. 19 is a schematic diagram illustrating a side view of the illumination of an optical valve apparatus, in accordance with the present disclosure;

FIG. 20 is a schematic diagram illustrating a side view of the illumination of an optical valve apparatus, in accordance with the present disclosure;

FIG. 21 is a schematic diagram illustrating a side view of a spatially multiplexed optical valve apparatus, in accordance with the present disclosure;

FIG. 22 is a schematic diagram illustrating a side view of a spatially multiplexed optical valve apparatus, in accordance with the present disclosure;

FIG. 23 is a schematic diagram illustrating a side view of a spatially multiplexed optical valve apparatus, in accordance with the present disclosure;

FIG. 24 is a schematic diagram illustrating a side view of a spatial light modulator for a spatially multiplexed optical valve apparatus, in accordance with the present disclosure;

FIG. 25 is a schematic diagram illustrating a plan view of an illumination apparatus for a spatially multiplexed optical valve apparatus, in accordance with the present disclosure;

FIG. 26 is a schematic diagram illustrating a plan view a spatially multiplexed optical valve apparatus, in accordance with the present disclosure;

FIG. 27 is a schematic diagram illustrating a side view of a spatial light modulator for a spatially multiplexed optical valve apparatus, in accordance with the present disclosure;

FIG. 28A is a schematic diagram illustrating a first side view of a spatial light modulator for a spatially multiplexed optical valve apparatus, in accordance with the present disclosure;

FIG. 28B is a schematic diagram illustrating a second side view of a spatial light modulator for a spatially multiplexed optical valve apparatus, in accordance with the present disclosure; and

FIG. 29 is a schematic diagram illustrating a side view of a spatial light modulator for a spatially multiplexed optical valve apparatus comprising light deflection diffractive optical elements, in accordance with the present disclosure.

### DETAILED DESCRIPTION

Time multiplexed autostereoscopic displays can advantageously improve the spatial resolution of autostereoscopic display by directing light from all of the pixels of a spatial light modulator to a first viewing window in a first time slot, and all of the pixels to a second viewing window in a second time slot. Thus an observer with eyes arranged to receive light in first and second viewing windows will see a full resolution image across the whole of the display over multiple time slots. Time multiplexed displays can advantageously achieve directional illumination by directing an illuminator array through a substantially transparent time multiplexed spatial light modulator using directional optical elements, wherein the directional optical elements substantially form an image of the illuminator array in the window plane.

The uniformity of the viewing windows may be advantageously independent of the arrangement of pixels in the spatial light modulator. Advantageously, such displays can provide observer tracking displays which have low flicker, with low levels of cross talk for a moving observer.

To achieve high uniformity in the window plane, it is desirable to provide an array of illumination elements that have a high spatial uniformity. The illuminator elements of the time sequential illumination system may be provided, for example, by pixels of a spatial light modulator with size approximately 100 micrometers in combination with a lens array. However, such pixels suffer from similar difficulties as for spatially multiplexed displays. Further, such devices may have low efficiency and higher cost, requiring additional display components.

High window plane uniformity can be conveniently achieved with macroscopic illuminators, for example, an array of LEDs in combination with homogenizing and diffusing optical elements that are typically of size 1 mm or greater. However, the increased size of the illuminator elements means that the size of the directional optical elements increases proportionately. For example, a 16 mm wide illuminator imaged to a 65 mm wide viewing window may require a 200 mm back working distance. Thus, the increased thickness of the optical elements can prevent useful application, for example, to mobile displays, or large area displays.

Addressing the aforementioned shortcomings, optical valves as described in commonly-owned U.S. patent application Ser. No. 13/300,293 advantageously can be arranged in combination with fast switching transmissive spatial light modulators to achieve time multiplexed autostereoscopic illumination in a thin package while providing high resolution images with flicker free observer tracking and low levels of cross talk. Described is a one dimensional array of viewing positions, or windows, that can display different images in a first, typically horizontal, direction, but contain the same images when moving in a second, typically vertical, direction.

Conventional non-imaging display backlights commonly employ optical waveguides and have edge illumination from light sources such as LEDs. However, it should be appreciated that there are many fundamental differences in the function, design, structure, and operation between such conventional non-imaging display backlights and the imaging directional backlights discussed in the present disclosure.

Generally, for example, in accordance with the present disclosure, imaging directional backlights are arranged to direct the illumination from multiple light sources through a display panel to respective multiple viewing windows in at least one axis. Each viewing window is substantially formed as an image in at least one axis of a light source by the imaging system of the imaging directional backlight. An imaging system may be formed between multiple light sources and the respective window images. In this manner, the light from each of the multiple light sources is substantially not visible for an observer's eye outside of the respective viewing window.

In contradistinction, conventional non-imaging backlights or light guiding plates (LGPs) are used for illumination of 2D displays. See, e.g., Kälil Käläntär et al., Backlight Unit With Double Surface Light Emission, J. Soc. Inf. Display, Vol. 12, Issue 4, pp. 379-387 (December 2004). Non-imaging backlights are typically arranged to direct the illumination from multiple light sources through a display panel into a substantially common viewing zone for each of the multiple light sources to achieve wide viewing angle and high display uniformity. Thus non-imaging backlights do not form viewing windows. In this manner, the light from each of the multiple light sources may be visible for an observer's eye at substantially all positions across the viewing zone. Such conventional non-imaging backlights may have some directionality, for example, to increase screen gain compared to Lambertian illumination, which may be provided by brightness enhancement films such as BEF™ from 3M. However, such directionality may be substantially the same for each of the respective light sources. Thus, for these reasons and others that should be apparent to persons of ordinary skill, conventional non-imaging backlights are different to imaging directional backlights. Edge lit non-imaging backlight illumination structures may be used in liquid crystal display systems such as those seen in 2D Laptops, Monitors and TVs. Light propagates from the edge of a lossy waveguide which may include sparse features; typically local indentations in the surface of the guide which cause light to be lost regardless of the propagation direction of the light.

As used herein, an optical valve is an optical structure that may be a type of light guiding structure or device referred to as, for example, a light valve, an optical valve directional backlight, and a valve directional backlight (“v-DBL”). In the present disclosure, optical valve is different to a spatial light modulator (which is sometimes referred to as a “light valve”). One example of an imaging directional backlight is an optical valve that may employ a folded optical system. Light may propagate substantially without loss in one direction through the optical valve, may be incident on an imaging reflector, and may counter-propagate such that the light may be extracted by reflection off tilted light extraction features, and directed to viewing windows as described in U.S. patent application Ser. No. 13/300,293, which is herein incorporated by reference in its entirety.

As used herein, examples of an imaging directional backlight include a stepped waveguide imaging directional backlight, a folded imaging directional backlight, a wedge type directional backlight, or an optical valve.

Additionally, as used herein, a stepped waveguide imaging directional backlight may be an optical valve. A stepped waveguide is a waveguide for an imaging directional backlight comprising a waveguide for guiding light, which may include a first light guiding surface and a second light guiding surface, opposite the first light guiding surface, further comprising a plurality of light guiding features interspersed with a plurality of extraction features arranged as steps.

Moreover, as used, a folded imaging directional backlight may be at least one of a wedge type directional backlight, or an optical valve.

In operation, light may propagate within an exemplary optical valve in a first direction from an input end to a reflective end and may be transmitted substantially without loss. Light may be reflected at the reflective end and propagates in a second direction substantially opposite the first direction. As the light propagates in the second direction, the light may be incident on light extraction features, which are operable to redirect the light outside the optical valve. Stated differently, the optical valve generally allows light to propagate in the first direction and may allow light to be extracted while propagating in the second direction.

The optical valve may achieve time sequential directional illumination of large display areas. Additionally, optical elements may be employed that are thinner than the back working distance of the optical elements to direct light from macroscopic illuminators to a nominal window plane. Such displays may use an array of light extraction features arranged to extract light counter propagating in a substantially parallel waveguide.

Thin imaging directional backlight implementations for use with LCDs have been proposed and demonstrated by 3M, for example U.S. Pat. No. 7,528,893; by Microsoft, for example U.S. Pat. No. 7,970,246 which may be referred to herein as a “wedge type directional backlight;” by RealD, for example U.S. patent application Ser. No. 13/300,293 which may be referred to herein as an “optical valve” or “optical valve directional backlight,” all of which are herein incorporated by reference in their entirety.

The present disclosure provides stepped waveguide imaging directional backlights in which light may reflect back and forth between the internal faces of, for example, a stepped waveguide which may include a first side and a first set of features. As the light travels along the length of the stepped waveguide, the light may not substantially change angle of incidence with respect to the first side and first set of surfaces and so may not reach the critical angle of the medium at these internal faces. Light extraction may be advantageously achieved by a second set of surfaces (the step “risers”) that are inclined to the first set of surfaces (the step “treads”). Note that the second set of surfaces may not be part of the light guiding operation of the stepped waveguide, but may be arranged to provide light extraction from the structure. By contrast, a wedge type imaging directional backlight may allow light to guide within a wedge profiled waveguide having continuous internal surfaces. The optical valve is thus not a wedge type imaging directional backlight.

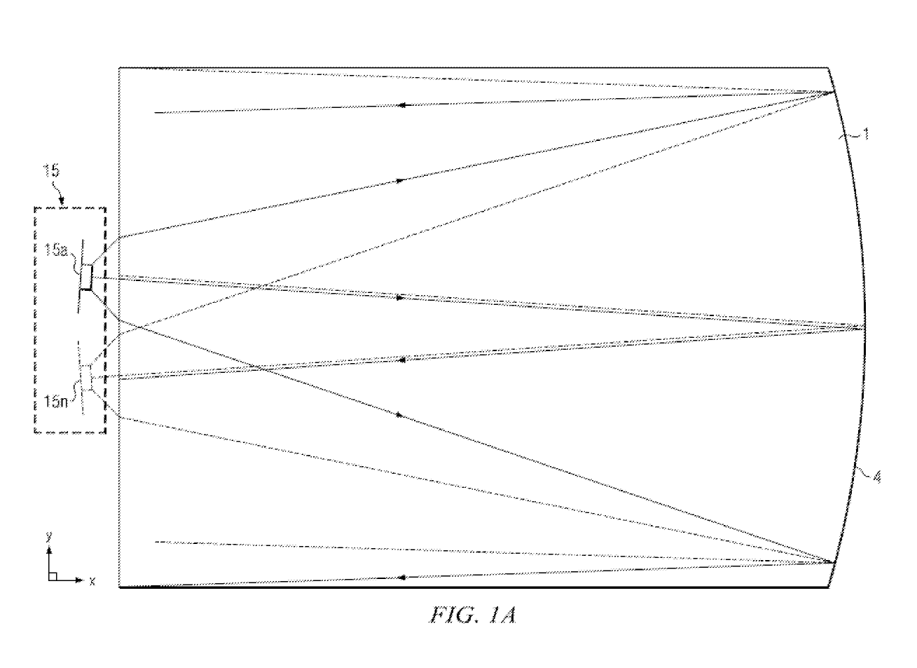

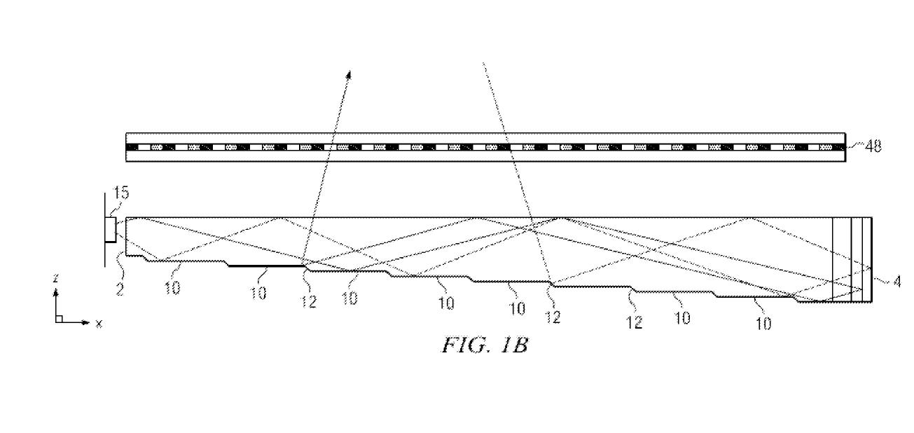

FIG. 1A is a schematic diagram illustrating a front view of light propagation in one embodiment of a directional display device, and FIG. 1B is a schematic diagram illustrating a side view of light propagation in the optical valve structure of FIG. 1A.

FIG. 1A illustrates a front view in the xy plane of a directional backlight of a directional display device, and includes an illuminator array 15 which may be used to illuminate a stepped waveguide 1. Illuminator array 15 includes illuminator elements 15a through illuminator element 15n (where n is an integer greater than one). In one example, the stepped waveguide 1 of FIG. 1A may be a stepped, display sized waveguide 1. Illuminator elements 15a through 15n are light sources that may be light emitting diodes (LEDs). Although LEDs are discussed herein as illuminator elements 15a-15n, other light sources may be used such as, but not limited to, diode sources, semiconductor sources, laser sources, local field emission sources, organic emitter arrays, and so forth. Additionally, FIG. 1B illustrates a side view in the xz plane, and includes illuminator array 15, SLM (spatial light modulator) 48, extraction features 12, guiding features 10, and stepped waveguide 1, arranged as shown. The side view provided in FIG. 1B is an alternative view of the front view shown in FIG. 1A. Accordingly, the illuminator array 15 of FIGS. 1A and 1B corresponds to one another and the stepped waveguide 1 of FIGS. 1A and 1B may correspond to one another.

Further, in FIG. 1B, the stepped waveguide 1 may have an input end 2 that is thin and a reflective end 4 that is thick. Thus the waveguide 1 extends between the input end 2 that receives input light and the reflective end 4 that reflects the input light back through the waveguide 1. The length of the input end 2 in a lateral direction across the waveguide is greater than the height of the input end 2. The illuminator elements 15a-15n are disposed at different input positions in a lateral direction across the input end 2.

The waveguide 1 has first and second, opposed guide surfaces extending between the input end 2 and the reflective end 4 for guiding light forwards and back along the waveguide 1 by total internal reflection. The first guide surface is planar. The second guide surface has a plurality of light extraction features 12 facing the reflective end 4 and inclined to reflect at least some of the light guided back through the waveguide 1 from the reflective end in directions that break the total internal reflection at the first guide surface and allow output through the first guide surface, for example, upwards in FIG. 1B, that is supplied to the SLM 48.

In this example, the light extraction features 12 are reflective facets, although other reflective features could be used. The light extraction features 12 do not guide light through the waveguide, whereas the intermediate regions of the second guide surface intermediate the light extraction features 12 guide light without extracting it. Those regions of the second guide surface are planar and may extend parallel to the first guide surface, or at a relatively low inclination. The light extraction features 12 extend laterally to those regions so that the second guide surface has a stepped shape including the light extraction features 12 and intermediate regions. The light extraction features 12 are oriented to reflect light from the light sources, after reflection from the reflective end 4, through the first guide surface.

The light extraction features 12 are arranged to direct input light from different input positions in the lateral direction across the input end in different directions relative to the first guide surface that are dependent on the input position. As the illumination elements 15a-15n are arranged at different input positions, the light from respective illumination elements 15a-15n is reflected in those different directions. In this manner, each of the illumination elements 15a-15n directs light into a respective optical window in output directions distributed in the lateral direction in dependence on the input positions. The lateral direction across the input end 2 in which the input positions are distributed corresponds with regard to the output light to a lateral direction to the normal to the first guide surface. The lateral directions as defined at the input end 2 and with regard to the output light remain parallel in this embodiment where the deflections at the reflective end 4 and the first guide surface are generally orthogonal to the lateral direction. Under the control of a control system, the illuminator elements 15a-15n may be selectively operated to direct light into a selectable optical window.

In the present disclosure an optical window may correspond to the image of a single light source in the window plane, being a nominal plane in which optical windows form across the entirety of the display device. Alternatively, an optical windows may correspond to the image of a groups of light sources that are driven together. Advantageously, such groups of light sources may increase uniformity of the optical windows of the array 121.

By way of comparison, a viewing window is a region in the window plane wherein light is provided comprising image data of substantially the same image from across the display area. Thus a viewing window may be formed from a single optical window or from plural optical windows.

The SLM 48 extends across the waveguide is transmissive and modulates the light passing therethrough. Although the SLM 48 may be a liquid crystal display (LCD) but this is merely by way of example, and other spatial light modulators or displays may be used including LCOS, DLP devices, and so forth, as this illuminator may work in reflection. In this example, the SLM 48 is disposed across the first guide surface of the waveguide and modulates the light output through the first guide surface after reflection from the light extraction features 12.

The operation of a directional display device that may provide a one dimensional array of viewing windows is illustrated in front view in FIG. 1A, with its side profile shown in FIG. 1B. In operation, in FIGS. 1A and 1B, light may be emitted from an illuminator array 15, such as an array of illuminator elements 15a through 15n, located at different positions, y, along the surface of thin end side 2, x=0, of the stepped waveguide 1. The light may propagate along +x in a first direction, within the stepped waveguide 1, while at the same time, the light may fan out in the xy plane and upon reaching the far curved end side 4, may substantially or entirely fill the curved end side 4. While propagating, the light may spread out to a set of angles in the xz plane up to, but not exceeding the critical angle of the guide material. The extraction features 12 that link the guiding features 10 of the bottom side of the stepped waveguide 1 may have a tilt angle greater than the critical angle and hence may be missed by substantially all light propagating along +x in the first direction, ensuring the substantially lossless forward propagation.

Continuing the discussion of FIGS. 1A and 1B, the curved end side 4 of the stepped waveguide 1 may be made reflective, typically by being coated with a reflective material such as, for example, silver, although other reflective techniques may be employed. Light may therefore be redirected in a second direction, back down the guide in the direction of −x and may be substantially collimated in the xy or display plane. The angular spread may be substantially preserved in the xz plane about the principal propagation direction, which may allow light to hit the riser edges and reflect out of the guide. In an embodiment with approximately 45 degree tilted extraction features 12, light may be effectively directed approximately normal to the xy display plane with the xz angular spread substantially maintained relative to the propagation direction. This angular spread may be increased when light exits the stepped waveguide 1 through refraction, but may be decreased somewhat dependent on the reflective properties of the extraction features 12.

In some embodiments with uncoated extraction features 12, reflection may be reduced when total internal reflection (TIR) fails, squeezing the xz angular profile and shifting off normal. However, in other embodiments having silver coated or metallized extraction features, the increased angular spread and central normal direction may be preserved. Continuing the description of the embodiment with silver coated extraction features, in the xz plane, light may exit the stepped waveguide 1 approximately collimated and may be directed off normal in proportion to the y-position of the respective illuminator element 15a-15n in illuminator array 15 from the input edge center. Having independent illuminator elements 15a-15n along the input edge 2 then enables light to exit from the entire first light directing side 6 and propagate at different external angles, as illustrated in FIG. 1A.

In one embodiment, a display device may include a stepped waveguide or light valve which in turn, may include a first guide surface that may be arranged to guide light by total internal reflection. The light valve may include a second guide surface which may have a plurality of light extraction features inclined to reflect light guided through the waveguide in directions allowing exit through the first guide surface as the output light. The second guide surface may also have regions between the light extraction features that may be arranged to direct light through the waveguide without extracting it.

In another embodiment, a display device may include a waveguide with at least a first guide surface which may be arranged to guide light by total internal reflection and a second guide surface which may be substantially planar and inclined at an angle to reflect light in directions that break the total internal reflection for outputting light through the first guide surface, The display device may include a deflection element extending across the first guide surface of the waveguide for deflecting light towards the normal to the SLM 48.

In yet another embodiment, a display device may include a waveguide which may have a reflective end facing the input end for reflecting light from the input light back through the waveguide. The waveguide may further be arranged to output light through the first guide surface after reflection from the reflective end.

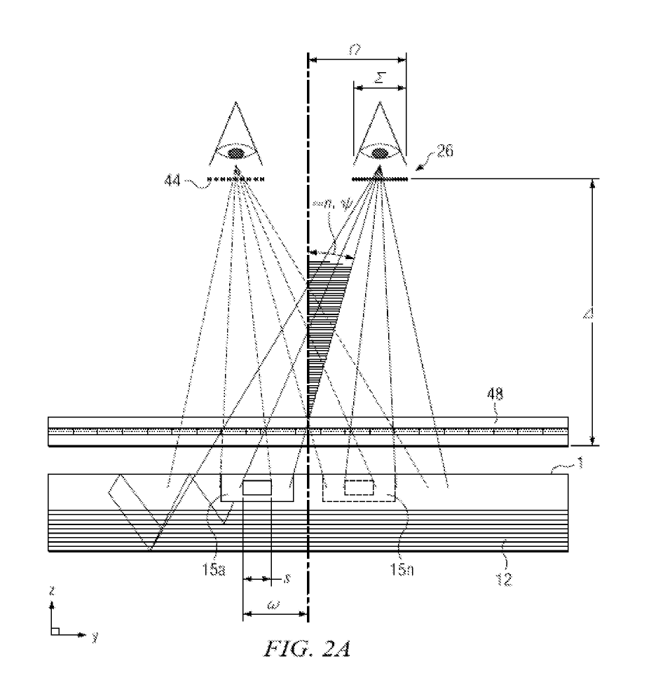

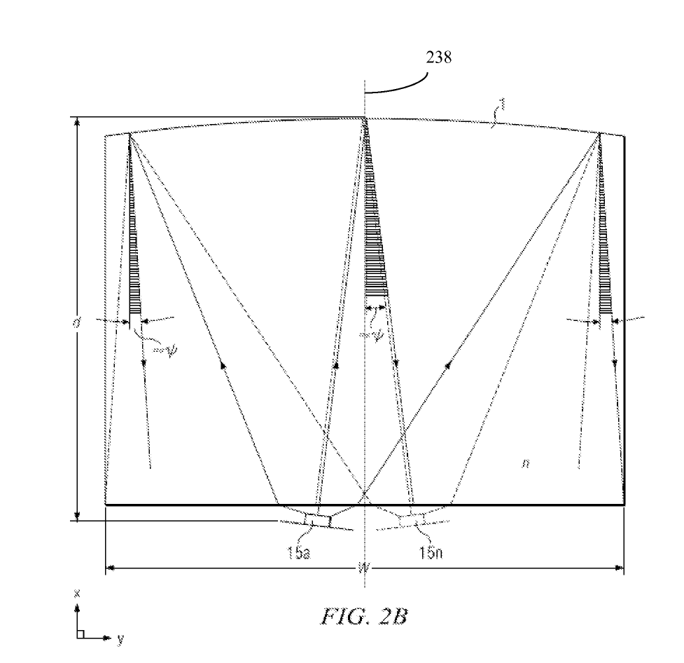

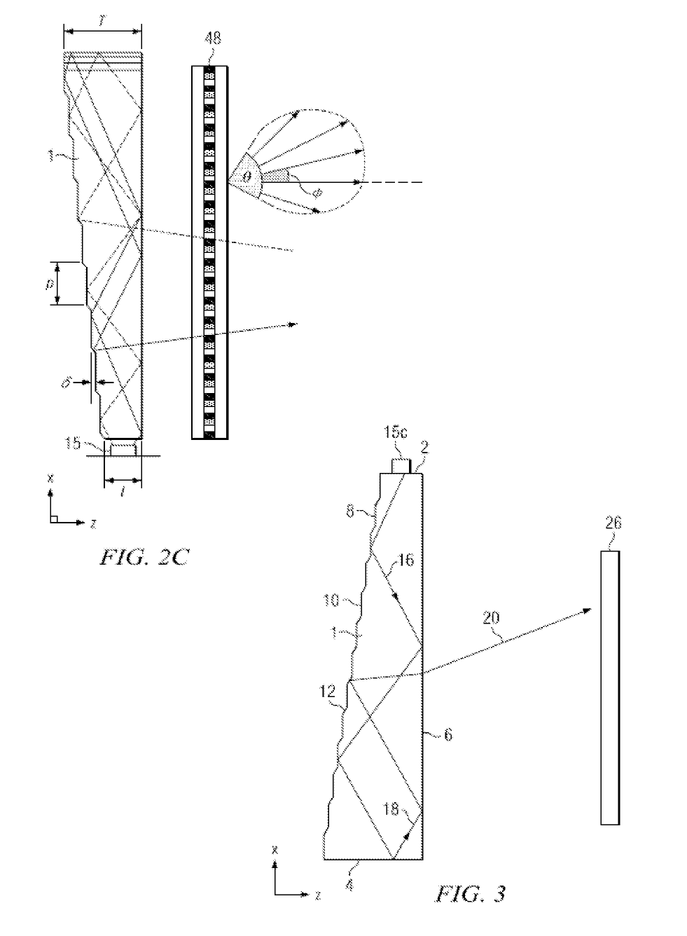

Illuminating an SLM 48 such as a fast liquid crystal display (LCD) panel with such a device may achieve autostereoscopic 3D as shown in top view or yz-plane viewed from the illuminator array 15 end in FIG. 2A, front view in FIG. 2B and side view in FIG. 2C. FIG. 2A is a schematic diagram illustrating in a top view, propagation of light in a directional display device, FIG. 2B is a schematic diagram illustrating in a front view, propagation of light in a directional display device, and FIG. 2C is a schematic diagram illustrating in side view propagation of light in a directional display device. As illustrated in FIGS. 2A, 2B, and 2C, a stepped waveguide 1 may be located behind a fast (e.g., greater than 100 Hz) LCD panel SLM 48 that displays sequential right and left eye images. In synchronization, specific illuminator elements 15a through 15n of illuminator array 15 (where n is an integer greater than one) may be selectively turned on and off, providing illuminating light that enters right and left eyes substantially independently by virtue of the system's directionality. In the simplest case, sets of illuminator elements of illuminator array 15 are turned on together, providing a one dimensional viewing window 26 or an optical pupil with limited width in the horizontal direction, but extended in the vertical direction, in which both eyes horizontally separated may view a left eye image, and another viewing window 44 in which a right eye image may primarily be viewed by both eyes, and a central position in which both the eyes may view different images. In this way, 3D may be viewed when the head of a viewer is approximately centrally aligned. Movement to the side away from the central position may result in the scene collapsing onto a 2D image.

The reflective end 4 may have positive optical power in the lateral direction across the waveguide. In embodiments in which typically the reflective end 4 has positive optical power, the optical axis may be defined with reference to the shape of the reflective end 4, for example being a line that passes through the centre of curvature of the reflective end 4 and coincides with the axis of reflective symmetry of the end 4 about the x-axis. In the case that the reflecting surface 4 is flat, the optical axis may be similarly defined with respect to other components having optical power, for example the light extraction features 12 if they are curved, or the Fresnel lens 62 described below. The optical axis 238 is typically coincident with the mechanical axis of the waveguide 1. In the present embodiments that typically comprise a substantially cylindrical reflecting surface at end 4, the optical axis 238 is a line that passes through the centre of curvature of the surface at end 4 and coincides with the axis of reflective symmetry of the side 4 about the x-axis. The optical axis 238 is typically coincident with the mechanical axis of the waveguide 1. The cylindrical reflecting surface at end 4 may typically comprise a spherical profile to optimize performance for on-axis and off-axis viewing positions. Other profiles may be used.

FIG. 3 is a schematic diagram illustrating in side view a directional display device. Further, FIG. 3 illustrates additional detail of a side view of the operation of a stepped waveguide 1, which may be a transparent material. The stepped waveguide 1 may include an illuminator input end 2, a reflective end 4, a first light directing side 6 which may be substantially planar, and a second light directing side 8 which includes guiding features 10 and light extraction features 12. In operation, light rays 16 from an illuminator element 15c of an illuminator array 15 (not shown in FIG. 3), that may be an addressable array of LEDs for example, may be guided in the stepped waveguide 1 by means of total internal reflection by the first light directing side 6 and total internal reflection by the guiding feature 10, to the reflective end 4, which may be a mirrored surface. Although reflective end 4 may be a mirrored surface and may reflect light, it may in some embodiments also be possible for light to pass through reflective end 4.

Continuing the discussion of FIG. 3, light ray 18 reflected by the reflective end 4 may be further guided in the stepped waveguide 1 by total internal reflection at the reflective end 4 and may be reflected by extraction features 12. Light rays 18 that are incident on extraction features 12 may be substantially deflected away from guiding modes of the stepped waveguide 1 and may be directed, as shown by ray 20, through the side 6 to an optical pupil that may form a viewing window 26 of an autostereoscopic display. The width of the viewing window 26 may be determined by at least the size of the illuminator, output design distance and optical power in the side 4 and extraction features 12. The height of the viewing window may be primarily determined by the reflection cone angle of the extraction features 12 and the illumination cone angle input at the input end 2. Thus each viewing window 26 represents a range of separate output directions with respect to the surface normal direction of the SLM 48 that intersect with a plane at the nominal viewing distance.

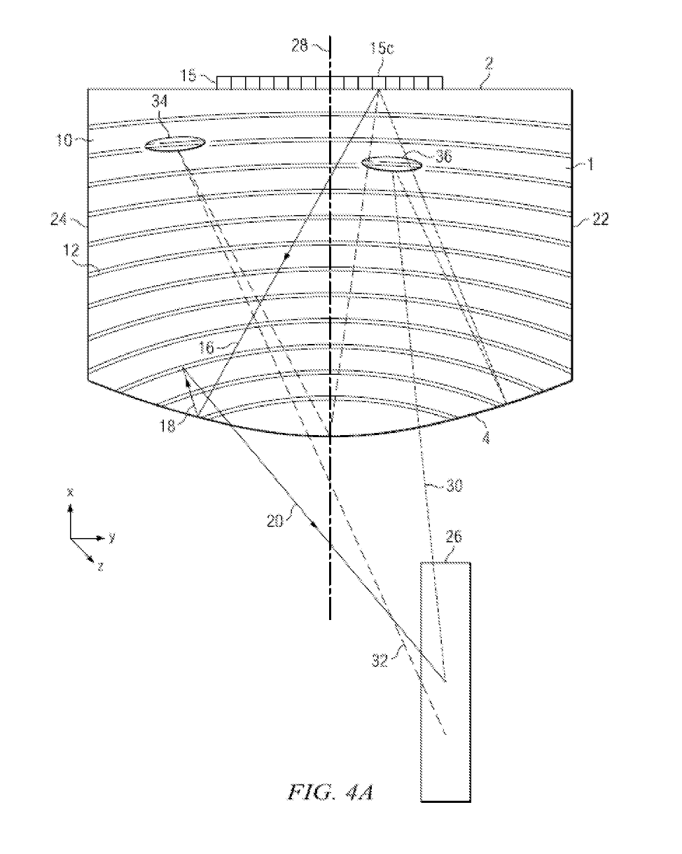

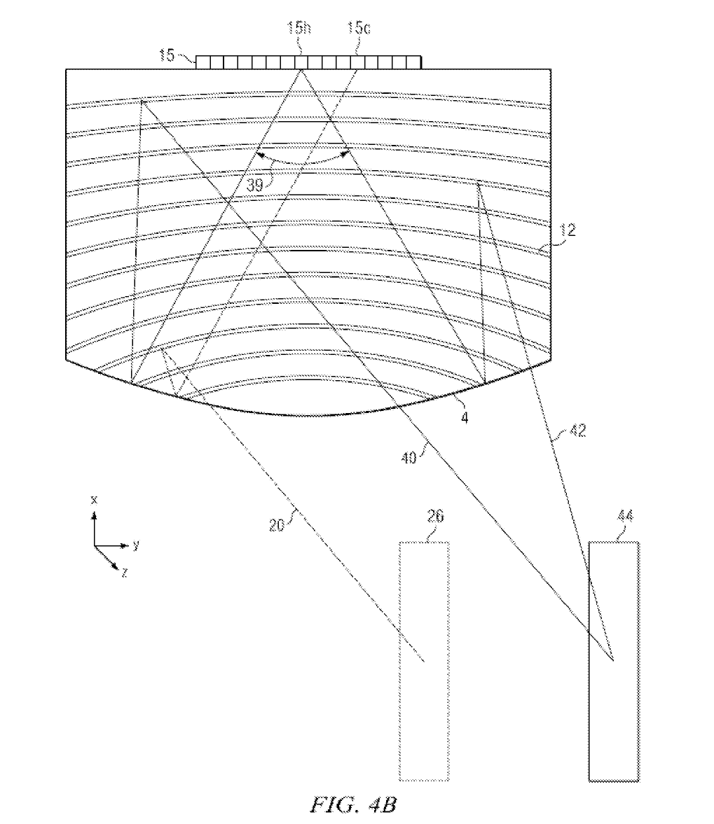

FIG. 4A is a schematic diagram illustrating in front view a directional display device which may be illuminated by a first illuminator element and including curved light extraction features. In FIG. 4A, the directional backlight may include the stepped waveguide 1 and the light source illuminator array 15. Further, FIG. 4A shows in front view further guiding of light rays from illuminator element 15c of illuminator array 15, in the stepped waveguide 1. Each of the output rays are directed towards the same viewing window 26 from the respective illuminator 14. Thus light ray 30 may intersect the ray 20 in the window 26, or may have a different height in the window as shown by ray 32. Additionally, in various embodiments, sides 22, 24 of the waveguide may be transparent, mirrored, or blackened surfaces. Continuing the discussion of FIG. 4A, light extraction features 12 may be elongate, and the orientation of light extraction features 12 in a first region 34 of the light directing side 8 (light directing side 8 shown in FIG. 3, but not shown in FIG. 4A) may be different to the orientation of light extraction features 12 in a second region 36 of the light directing side 8.

FIG. 4B is a schematic diagram illustrating in front view a directional display device which may illuminated by a second illuminator element. Further, FIG. 4B shows the light rays 40, 42 from a second illuminator element 15h of the illuminator array 15. The curvature of the reflective surface on the side 4 and the light extraction features 12 cooperatively produce a second viewing window 44 laterally separated from the viewing window 26 with light rays from the illuminator element 15h.

Advantageously, the arrangement illustrated in FIG. 4B may provide a real image of the illuminator element 15c at a viewing window 26 in which the real image may be formed by cooperation of optical power in reflective end 4 and optical power which may arise from different orientations of elongate light extraction features 12 between regions 34 and 36, as shown in FIG. 4A. The arrangement of FIG. 4B may achieve improved aberrations of the imaging of illuminator element 15c to lateral positions in viewing window 26. Improved aberrations may achieve an extended viewing freedom for an autostereoscopic display while achieving low cross talk levels.

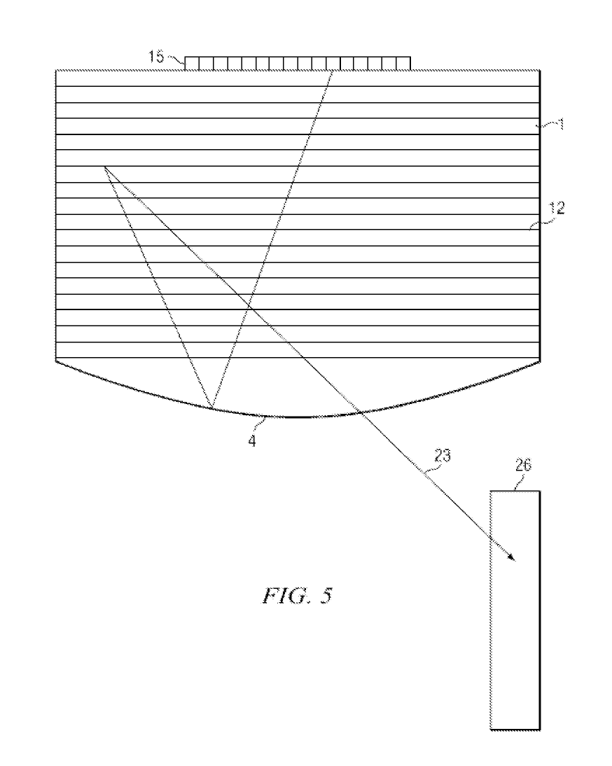

FIG. 5 is a schematic diagram illustrating in front view an embodiment of a directional display device comprising a waveguide 1 having substantially linear light extraction features. Further, FIG. 5 shows a similar arrangement of components to FIG. 1 (with corresponding elements being similar), with one of the differences being that the light extraction features 12 are substantially linear and parallel to each other. Advantageously, such an arrangement may provide substantially uniform illumination across a display surface and may be more convenient to manufacture than the curved extraction features of FIG. 4A and FIG. 4B.

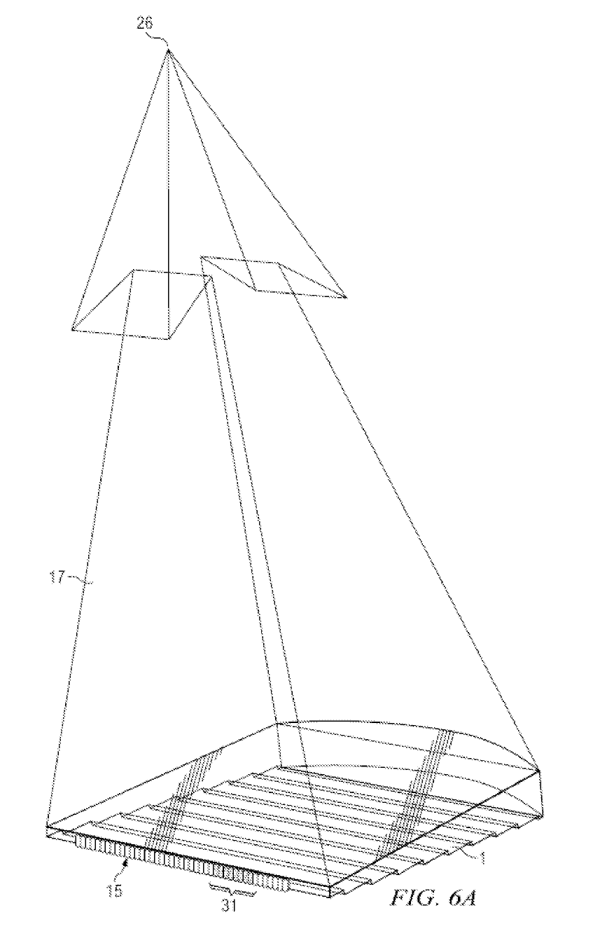

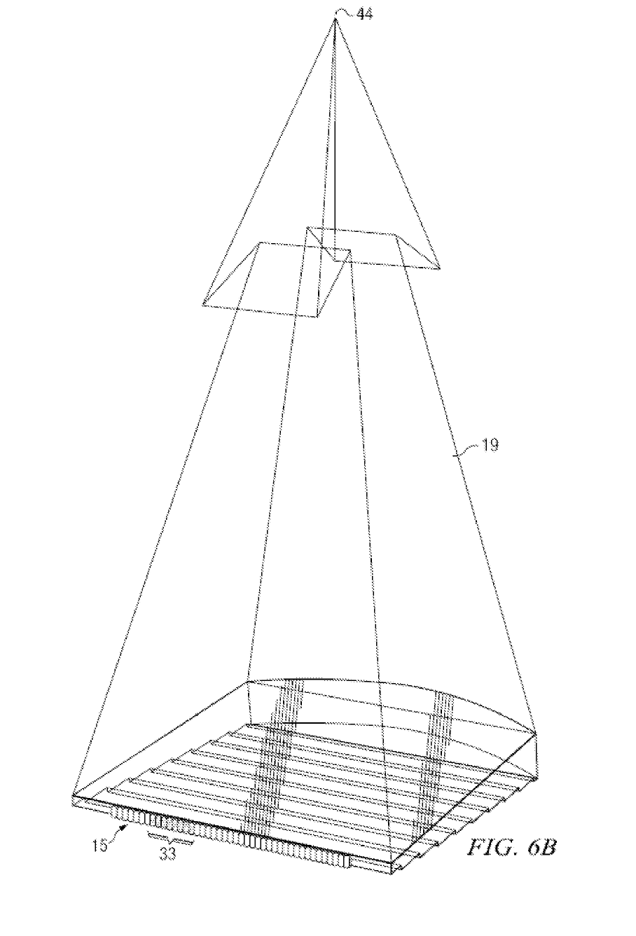

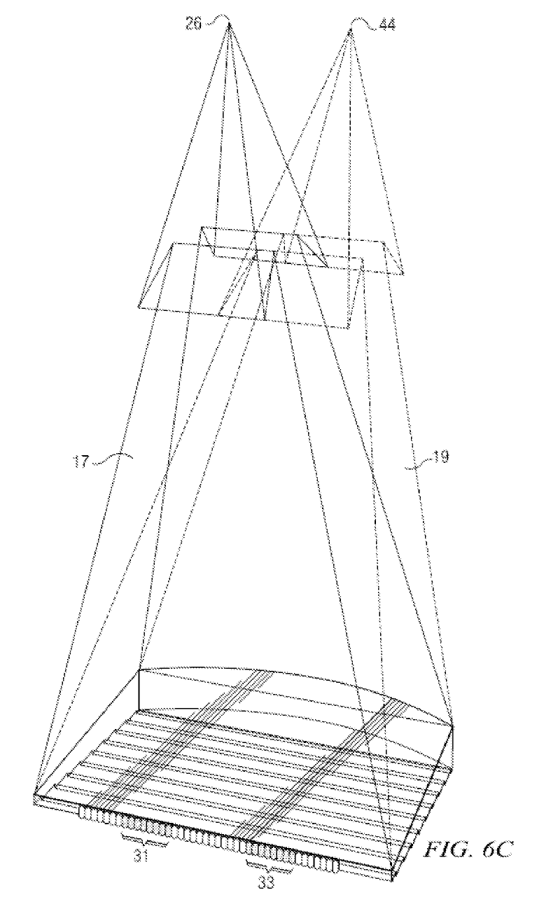

FIG. 6A is a schematic diagram illustrating one embodiment of the generation of a first viewing window in a time multiplexed imaging directional display device, namely an optical valve apparatus in a first time slot. FIG. 6B is a schematic diagram illustrating another embodiment of the generation of a second viewing window in a time multiplexed imaging directional backlight apparatus in a second time slot. FIG. 6C is a schematic diagram illustrating another embodiment of the generation of a first and a second viewing window in a time multiplexed imaging directional display device. Further, FIG. 6A shows schematically the generation of illumination window 26 from stepped waveguide 1. Illuminator element group 31 in illuminator array 15 may provide a light cone 17 directed towards a viewing window 26. FIG. 6B shows schematically the generation of illumination window 44. Illuminator element group 33 in illuminator array 15 may provide a light cone 19 directed towards viewing window 44. In cooperation with a time multiplexed display, windows 26 and 44 may be provided in sequence as shown in FIG. 6C. If the image on a SLM 48 (not shown in FIGS. 6A, 6B, 6C) is adjusted in correspondence with the light direction output, then an autostereoscopic image may be achieved for a suitably placed viewer. Similar operation can be achieved with all the directional backlights and directional display devices described herein. Note that illuminator element groups 31, 33 each include one or more illumination elements from illumination elements 15a to 15n, where n is an integer greater than one.

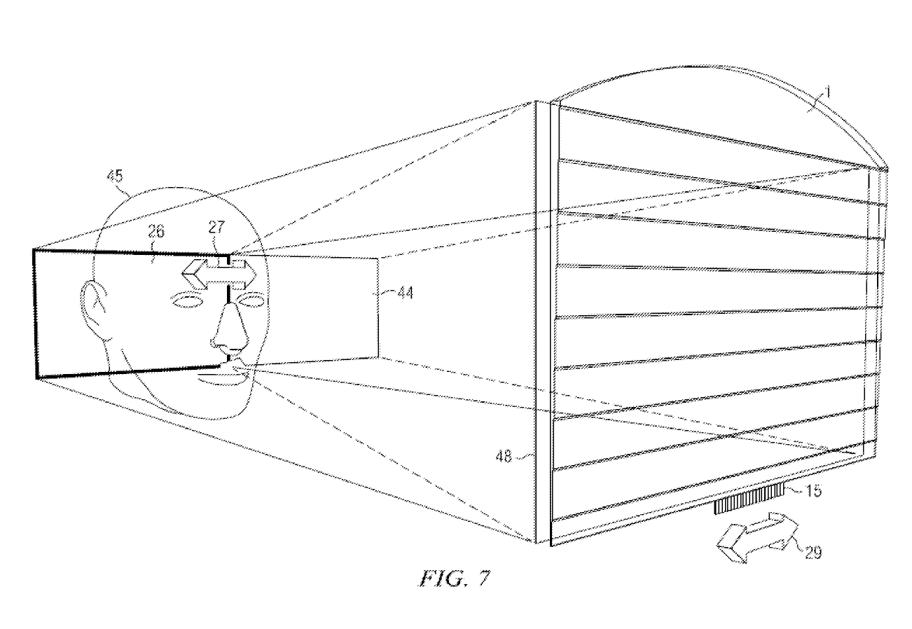

FIG. 7 is a schematic diagram illustrating one embodiment of an observer tracking autostereoscopic directional display device including a time multiplexed directional backlight. As shown in FIG. 7, selectively turning on and off illuminator elements 15a to 15n along axis 29 provides for directional control of viewing windows. The head 45 position may be monitored with a camera, motion sensor, motion detector, or any other appropriate optical, mechanical or electrical means, and the appropriate illuminator elements of illuminator array 15 may be turned on and off to provide substantially independent images to each eye irrespective of the head 45 position. The head tracking system (or a second head tracking system) may provide monitoring of more than one head 45, 47 (head 47 not shown in FIG. 7) and may supply the same left and right eye images to each viewers' left and right eyes providing 3D to all viewers. Again similar operation can be achieved with all the directional backlights and directional display devices described herein.

FIG. 8 is a schematic diagram illustrating one embodiment of a multi-viewer directional display device as an example including an imaging directional backlight. As shown in FIG. 8, at least two 2D images may be directed towards a pair of viewers 45, 47 so that each viewer may watch a different image on the SLM 48. The two 2D images of FIG. 8 may be generated in a similar manner as described with respect to FIG. 7 in that the two images would be displayed in sequence and in synchronization with sources whose light is directed toward the two viewers. One image is presented on the SLM 48 in a first phase, and a second image is presented on the SLM 48 in a second phase different from the first phase. In correspondence with the first and second phases, the output illumination is adjusted to provide first and second viewing windows 26, 44 respectively. An observer with both eyes in window 26 will perceive a first image while an observer with both eyes in window 44 will perceive a second image.

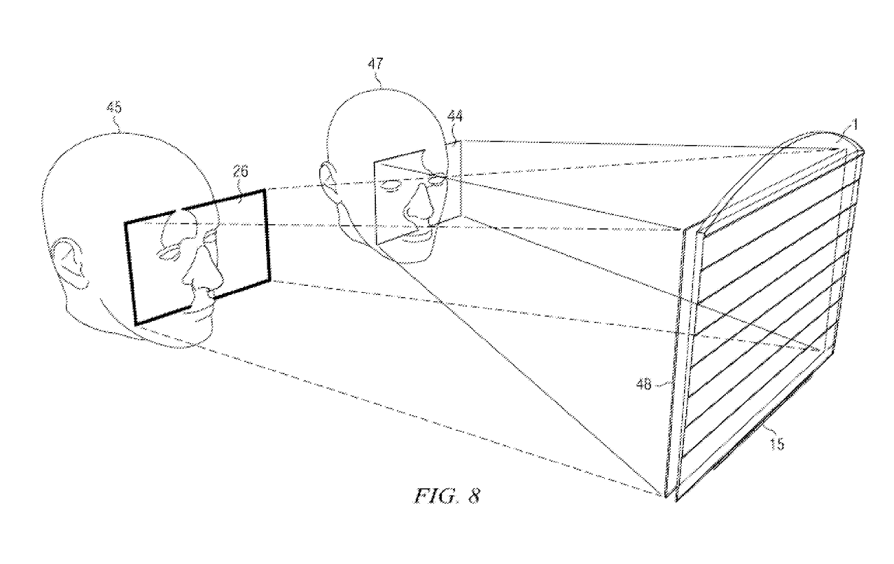

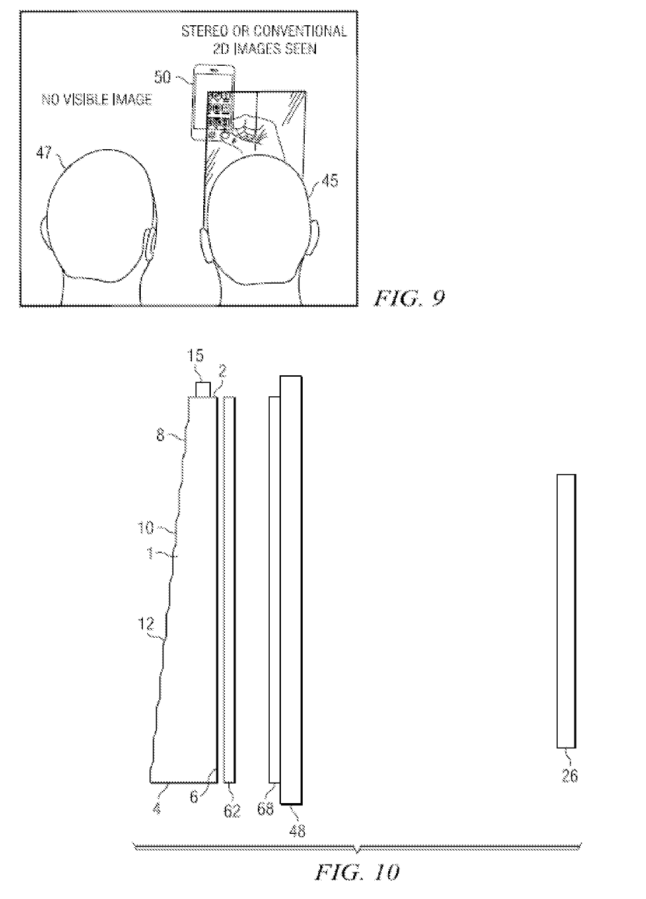

FIG. 9 is a schematic diagram illustrating a privacy directional display device which includes an imaging directional backlight. 2D image display systems may also utilize directional backlighting for security and efficiency purposes in which light may be primarily directed at the eyes of a first viewer 45 as shown in FIG. 9. Further, as illustrated in FIG. 9, although first viewer 45 may be able to view an image on device 50, light is not directed towards second viewer 47. Thus second viewer 47 is prevented from viewing an image on device 50. Each of the embodiments of the present disclosure may advantageously provide autostereoscopic, dual image or privacy display functions.

FIG. 10 is a schematic diagram illustrating in side view the structure of a time multiplexed directional display device as an example including an imaging directional backlight. Further, FIG. 10 shows in side view an autostereoscopic directional display device, which may include the stepped waveguide 1 and a Fresnel lens 62 arranged to provide the viewing window 26 for a substantially collimated output across the stepped waveguide 1 output surface. A vertical diffuser 68 may be arranged to extend the height of the window 26 further. The light may then be imaged through the SLM 48. The illuminator array 15 may include light emitting diodes (LEDs) that may, for example, be phosphor converted blue LEDs, or may be separate RGB LEDs. Alternatively, the illuminator elements in illuminator array 15 may include a uniform light source and SLM 48 arranged to provide separate illumination regions. Alternatively the illuminator elements may include laser light source(s). The laser output may be directed onto a diffuser by means of scanning, for example, using a galvo or MEMS scanner. In one example, laser light may thus be used to provide the appropriate illuminator elements in illuminator array 15 to provide a substantially uniform light source with the appropriate output angle, and further to provide reduction in speckle. Alternatively, the illuminator array 15 may be an array of laser light emitting elements. Additionally in one example, the diffuser may be a wavelength converting phosphor, so that illumination may be at a different wavelength to the visible output light.

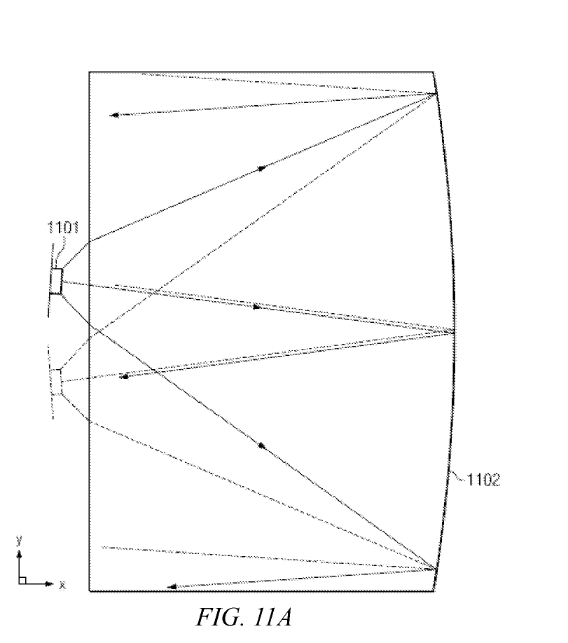

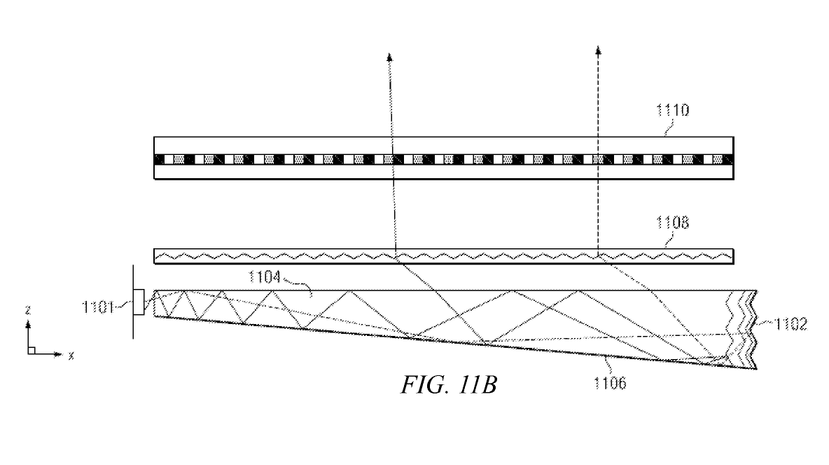

FIG. 11A is a schematic diagram illustrating a front view of another imaging directional display device, as illustrated, a wedge type directional backlight, and FIG. 11B is a schematic diagram illustrating a side view of the same wedge type directional display device. A wedge type directional backlight is generally discussed by U.S. Pat. No. 7,660,047 and entitled “Flat Panel Lens,” which is herein incorporated by reference in its entirety. The structure may include a wedge type waveguide 1104 with a bottom surface which may be preferentially coated with a reflecting layer 1106 and with an end corrugated surface 1102, which may also be preferentially coated with a reflecting layer 1106. As shown in FIG. 11B, light may enter the wedge type waveguide 1104 from local sources 1101 and the light may propagate in a first direction before reflecting off the end surface. Light may exit the wedge type waveguide 1104 while on its return path and may illuminate a display panel 1110. By way of comparison with an optical valve, a wedge type waveguide provides extraction by a taper that reduces the incidence angle of propagating light so that when the light is incident at the critical angle on an output surface, it may escape. Escaping light at the critical angle in the wedge type waveguide propagates substantially parallel to the surface until deflected by a redirection layer 1108 such as a prism array. Errors or dust on the wedge type waveguide output surface may change the critical angle, creating stray light and uniformity errors. Further, an imaging directional backlight that uses a mirror to fold the beam path in the wedge type directional backlight may employ a faceted mirror that biases the light cone directions in the wedge type waveguide. Such faceted mirrors are generally complex to fabricate and may result in illumination uniformity errors as well as stray light.

The wedge type directional backlight and optical valve further process light beams in different ways. In the wedge type waveguide, light input at an appropriate angle will output at a defined position on a major surface, but light rays will exit at substantially the same angle and substantially parallel to the major surface. By comparison, light input to a stepped waveguide of an optical valve at a certain angle may output from points across the first side, with output angle determined by input angle. Advantageously, the stepped waveguide of the optical valve may not require further light re-direction films to extract light towards an observer and angular non-uniformities of input may not provide non-uniformities across the display surface.

Thus a directional backlight may comprise a waveguide having an input end; and an array of light sources disposed at different input positions in a lateral direction across the input end of the waveguide, the waveguide may further comprise first and second, opposed guide surfaces for guiding light along the waveguide, and a reflective end facing the input end for reflecting input light from the input sources back through the waveguide, the waveguide being arranged to direct input light from the light sources as output light through the first guide surface after reflection from the reflective end into optical windows in output directions distributed in a lateral direction to the normal to the first guide surface that are dependent on the input positions.

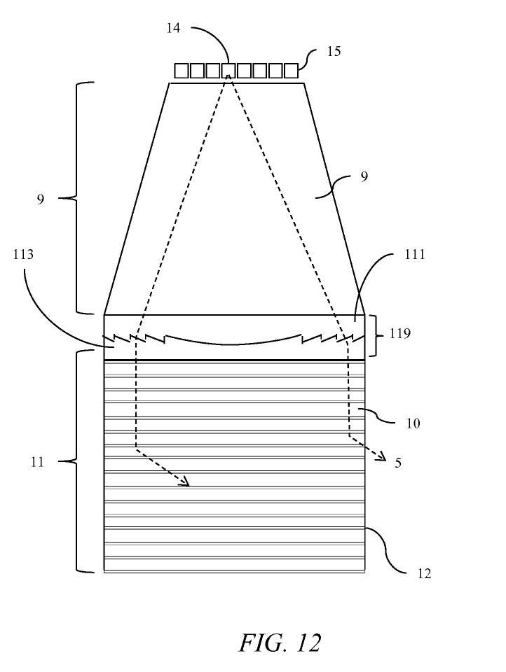

FIG. 12 is a schematic diagram illustrating a front view of an optical inline directional backlight apparatus as another example of an imaging directional backlight apparatus. Further, FIG. 12 shows another imaging directional backlight apparatus described herein as an optical inline directional backlight. The optical inline directional backlight may operate in a similar manner to the optical valve, with the difference that light may not be reversed at the end interface. Instead, the optical inline directional backlight may allow light to fan out in a guiding region before refracting light approximately half way down its length into a region containing extraction features 12 and in which light may be directed out of the guide and toward a viewer. Light emitted from an illuminator element 15d (e.g., LED) may expand within a guiding region 9 before being redirected with a refractive imaging element 119, which may include in this case, a Fresnel lens surface between dissimilar refractive index materials 111 and 113. Extraction features 12 may extract the light between guiding regions 10 to provide directed rays 5, which may converge to form viewing windows in a similar manner to the optical valve. Effectively, the optical inline directional backlight can be constructed and may operate as an unfolded optical valve in which the reflecting mirror 4 may be replaced by the refractive cylindrical lens 119.

There follows a description of some directional display apparatuses including a directional display device and a control system, wherein the directional display device includes a directional backlight including a waveguide and an SLM. In the following description, the waveguides, directional backlights and directional display devices are based on and incorporate the structures of FIGS. 1 to 12 above. Except for the modifications and/or additional features which will now be described, the above description applies equally to the following waveguides, directional backlights and display devices, but for brevity will not be repeated.

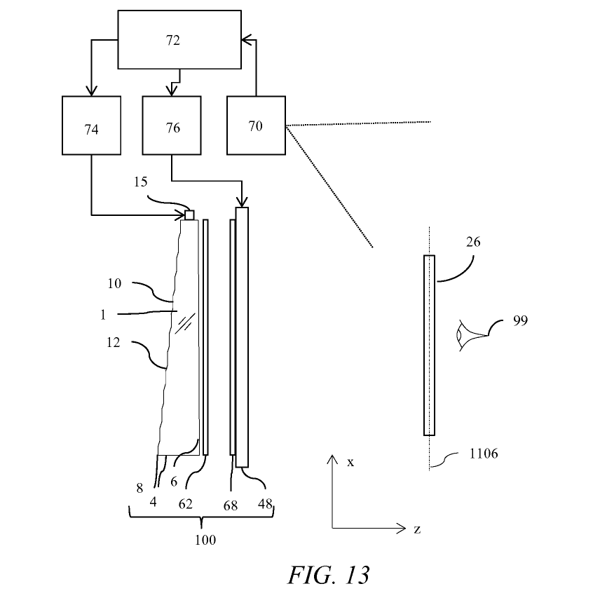

FIG. 13 is a schematic diagram illustrating a directional display apparatus comprising a display device 100 and a control system. The arrangement and operation of the control system will now be described and may be applied, with appropriate modifications, to each of the display devices disclosed herein. As illustrated in FIG. 13, a directional display device 100 may include a directional backlight device that may itself include a stepped waveguide 1 and a light source illuminator array 15. As illustrated in FIG. 13, the stepped waveguide 1 includes a light directing side 8, a reflective end 4, guiding features 10 and light extraction features 12. The directional display device 100 may further include an SLM 48.

The waveguide 1 is arranged as described above. The reflective end 4 converges the reflected light. A Fresnel lens 62 may be arranged to cooperate with reflective end 4 to achieve viewing windows 26 at a viewing plane 1106 observed by an observer 99. A transmissive SLM 48 may be arranged to receive the light from the directional backlight. Further a diffuser 68 may be provided to substantially remove Moiré beating between the waveguide 1 and pixels of the SLM 48 as well as the Fresnel lens structure 62.

The control system may comprise a sensor system arranged to detect the position of the observer 99 relative to the display device 100. The sensor system comprises a position sensor 70, such as a camera, and a head position measurement system 72 that may for example comprise a computer vision image processing system. The control system may further comprise an illumination controller 74 and an image controller 76 that are both supplied with the detected position of the observer supplied from the head position measurement system 72.

The illumination controller 74 selectively operates the illuminator elements 15 to direct light to into the viewing windows 26 in cooperation with waveguide 1. The illumination controller 74 selects the illuminator elements 15 to be operated in dependence on the position of the observer detected by the head position measurement system 72, so that the viewing windows 26 into which light is directed are in positions corresponding to the left and right eyes of the observer 99. In this manner, the lateral output directionality of the waveguide 1 corresponds with the observer position.

The image controller 76 controls the SLM 48 to display images. To provide an autostereoscopic display, the image controller 76 and the illumination controller 74 may operate as follows. The image controller 76 controls the SLM 48 to display spatially multiplexed left and right eye images. The illumination controller 74 operate the light sources 15 to direct light into respective viewing windows in positions corresponding to the left and right eyes of an observer with image data encoded by means of spatial multiplexing on the SLM 48. In this manner, an autostereoscopic effect is achieved using a spatial division multiplexing technique with directional illumination.

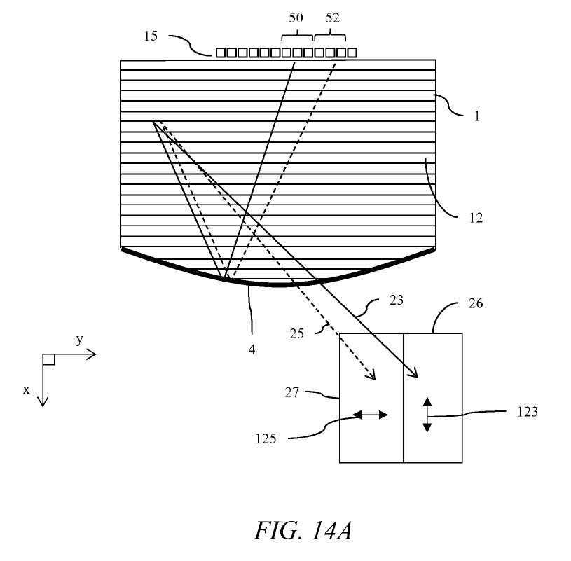

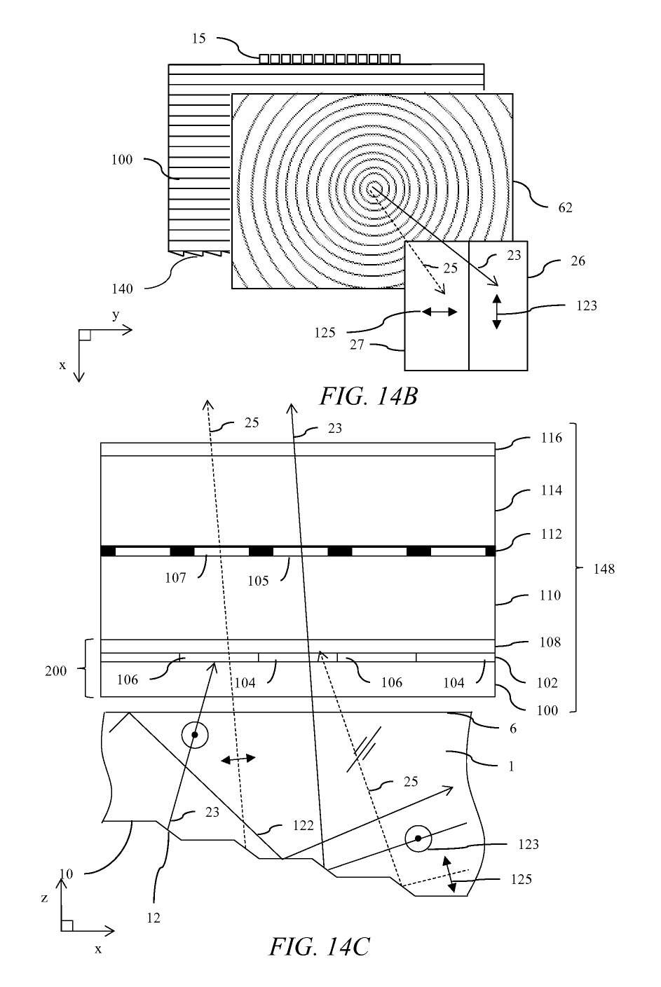

FIG. 14A is a schematic diagram illustrating in plan view an imaging directional backlight apparatus arranged to provide two viewing windows 26, 27. A first group 50 of light emitting elements in array 15 are arranged to direct light along rays 23 to window 26 such that light in the window 26 has a first polarization state 123. A second group 52 of light emitting elements are arranged to direct light along rays 25 to viewing window 27. The polarization state 125 of the light in viewing window 27 is arranged to be orthogonal to the polarization state 123 of light in viewing window 26. Viewing windows 26 and 27 may comprise multiple optical windows. Optical windows are provided by images of the light sources 15n of array 15 in the window plane 1106. Thus a viewing window may be achieved by illumination of multiple light sources with the same output polarisation from the backlight for the respective viewing window.

FIG. 14B is a schematic diagram illustrating an imaging directional backlight apparatus arranged to provide two viewing windows 26, 27 wherein a Fresnel type reflective mirror 140 is arranged at the side 4 of the imaging directional backlight, and an output Fresnel lens 62 is arranged to receive light from the light emitting element array 15 and direct to the windows 26, 27 along rays 23, 25 respectively. The position of the respective groups 50, 52 of light emitting elements in the array 15 may be adjusted to provide movement of the polarized viewing windows 26, 27, to achieve an observer tracking function such that the windows are arranged to move in correspondence with a measured observer position. Thus the light rays 23, 25 from the first guide surface 6 of the waveguide 100 may be provided with first and second polarisation directions 123, 125.

FIG. 14C is a schematic diagram in cross section illustrating the arrangement and operation of a spatially multiplexed autostereoscopic display comprising an imaging directional backlight, for example as shown in FIGS. 12 and 13. An optical valve 1 is arranged to direct light rays 23 with polarization state 123 and light rays 25 with polarization state 125 towards a spatial light modulator 148. SLM 148 comprises a substrate 100, patterned retarder array 102, polarizer 108, substrate 110, pixel layer 112 (which may be a liquid crystal layer), substrate 114 and polarizer 118. Substrates 100, 110, 114 may typically comprise glass but may comprise other transparent substrates such as plastic.

In operation, light rays 122 from array 15 propagate along the optical valve 1 in a first direction and are then reflected at side 4 (not shown) to counter propagate in the optical valve whereon they may be reflected towards the SLM 148 by means of light extraction features 12. The light rays 23 propagating within the valve 1 may have a first polarization state 123 and light rays 25 may have a second polarization state 125. The patterned retarder layer 102 may comprise rows of half wave retarders 104 with a first orientation and rows of half wave retarders 106 with a second orientation. Light rays 25 are absorbed by retarder 104 and polarizer 108; light rays 23 are absorbed by retarder 106 and polarizer 108. Thus light rays 23 are transmitted through rows pixels 105 and directed to viewing window 26, whereas light rays 25 are transmitted through rows of pixels 107 and directed to viewing window 27 (viewing windows 26 and 27 not shown in FIG. 14C). Thus, an observer with a right eye in window 26 will see image data from rows of pixels 105 and with a left eye in window 27 will see image data from rows of pixels 107. If right and left eye data are arranged on rows 105, 107 respectively, an autostereoscopic image may be perceived by the observer.

Advantageously, the present embodiment achieves an autostereoscopic display with a thin directional backlight. Further, the SLM 148 can be achieved with slower switching liquid crystal modes and addressing electronics, reducing cost. Further the illumination time of the SLM is increased compared to time multiplexed displays, which may increase efficiency and/or brightness of the display.

Thus a direction splitting optical element 200 comprising retarder array 102 and polariser 108 may be arranged to receive light from the first guide surface 6 and direct said light into at least two separate optical windows 26, 27.

A display device may thus comprise the directional backlight and a transmissive spatial light modulator arranged to receive the output light from the first guide surface and to modulate it to display an image. The direction splitting optical elements may be arranged in an array with first and second orientations; wherein the pixels of the spatial light modulator are aligned in an array; and the arrays of direction splitting optical elements and pixels are aligned.

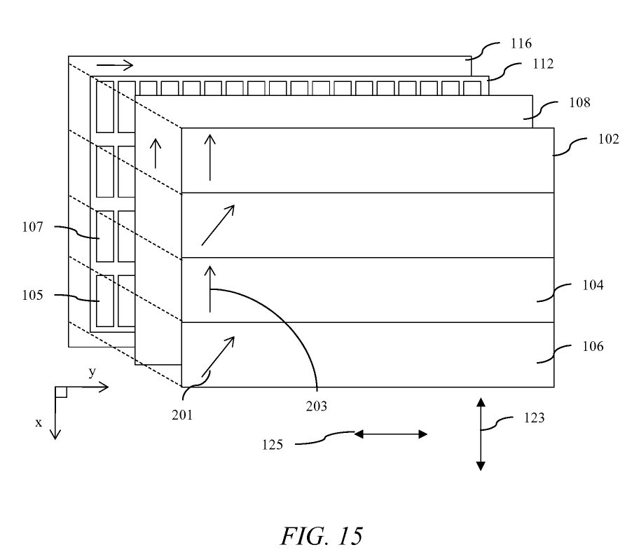

FIG. 15 is a schematic diagram in plan view illustrating the arrangement of retarders, pixels and polarizers in the embodiment of FIG. 14C. Polarization state 123 for light from the valve directed towards window 26 is approximately parallel to the retarder axis of retarder 104 and is thus un-rotated and transmitted through polarizer 108. State 123 is rotated through approximately 90 degrees by retarder 106 with half wave retardance and orientation of about 45 degrees, such that it is incident on the absorbing axis of polarizer 108 and is thus absorbed. In a similar manner polarization state 125 is rotated by about 90 degrees to be transmitted by polarizer 108 in the region of retarders 106 and absorbed by polarizer 108 in the region of retarders 104.

Rows of pixels 105 are approximately aligned with retarders 106 and thus see light directed to viewing window 26, and rows of pixels 107 are approximately aligned with retarders 104 and see light directed to viewing window 27.

The retarders may comprise half wave function, and may comprise stacks of retarders arranged to achieve wider spectral bandwidth than a single retarder layer, for example Pancharatnum retarder stacks. The first and second polarizers may thus comprise a uniform polarizer 108 and a retarder layer 102, in which the retarder layer 102 may include an array of alternating regions of optical axis directions 201, 203.

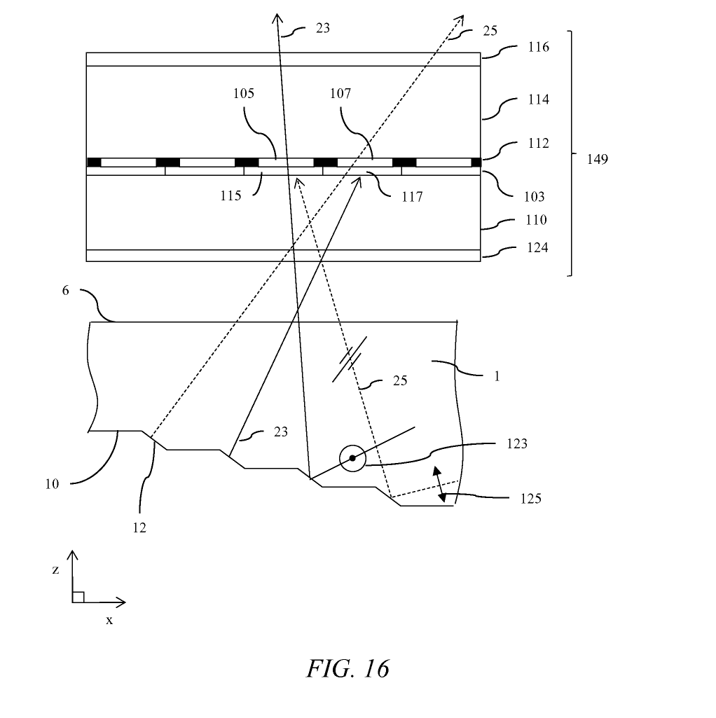

FIG. 16 is a schematic diagram in side view illustrating the arrangement and operation of a further spatially multiplexed imaging direction backlight autostereoscopic display. In another embodiment, the layer 102 and polarizer 108 of FIG. 15 may be removed and replaced by a patterned polarizer array in layer 103 comprising first and second rows of absorbing polarizer elements 115, 117. An additional waveplate 124 may be arranged at the input of the SLM 149. Light rays 23 are thus transmitted by polarizers 115 in alignment with pixels 105, and absorbed by polarizers 117 in approximate alignment with pixels 107. Similarly light rays 25 are transmitted by polarizers 117 and absorbed by polarizers 115. Thus, light rays to windows 26, 27 comprise image information from pixels 105, 107, respectively.

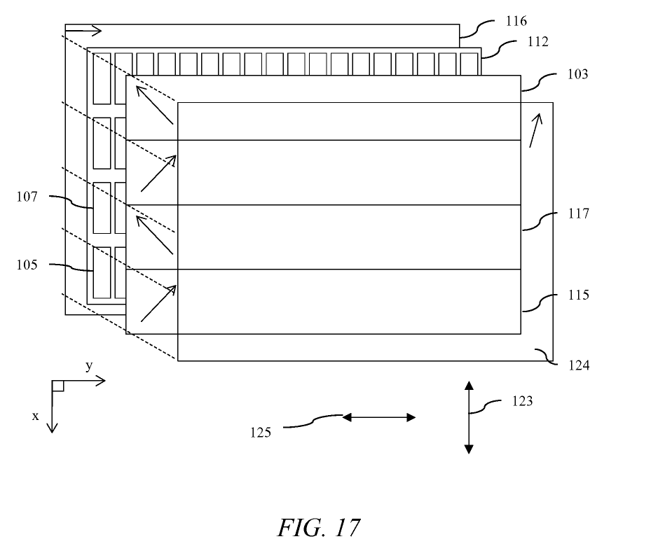

FIG. 17 is a schematic diagram in plan view illustrating the arrangement of retarder, pixels and polarizers in the embodiment of FIG. 16. Retarder 124 has an optical axis direction of approximately 22.5 degrees, and polarizers 115, 117 are arranged in rows with axes of about +/−45 degrees, and approximately aligned to rows of pixels 105, 107, respectively.

Polarized light rays 23, 25 propagating in the optical valve may be provided with vertical and horizontal polarization states to avoid depolarization at reflection from features 10 and side 6. However, liquid crystal layer in pixel 112 may preferentially be provided with an approximately 45 degree axis to optimise viewing angle. The polarizers 115, 117 are thus advantageously arranged with an approximately +/−45 degree orientation to increase contrast between the two polarization states, reducing image cross talk.

The present embodiments may be achieved with polarizers that are close to the pixel layer 112 of the SLM 148. Thus, the parallax between the layers 103, 112 is reduced so that advantageously the vertical viewing angle of the display without image cross talk is increased. The polarizers may comprise for example wire grid polarizers that may be suitable for processing in liquid crystal substrate manufacturing equipment.

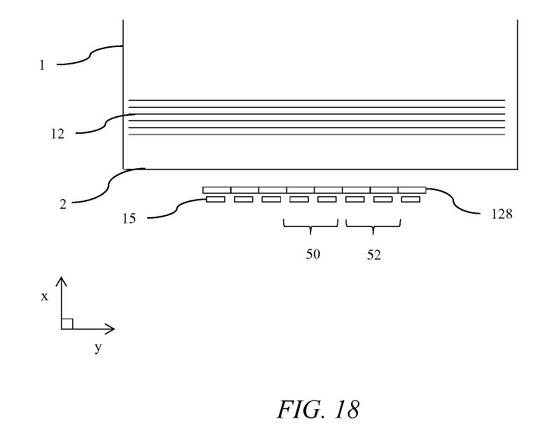

FIG. 18 is a schematic diagram in plan view illustrating an arrangement of optical valve and light emitting element array 15. The light emitting elements of the array 15 may be provided with a polarizer element array 128. The array 128 may comprise a segmented switchable shutter and polarizer to dynamically switch the output polarization state of the respective aligned light emitting element. Thus, elements of group 50 may be polarized with a first polarization state 123 and elements of group 52 may be polarized with a second polarization state 125 for input into the valve 1. As the observer position changes, the position of the illuminated groups 50, 52 and array 128 output may be modified, so that the observer advantageously achieves an autostereoscopic image across a wide range of viewing positions. Thus the light from the first guide surface is provided with first and second polarisation directions by a polariser element 128 arranged between the light sources 15 and the input end 2 of the waveguide 1.

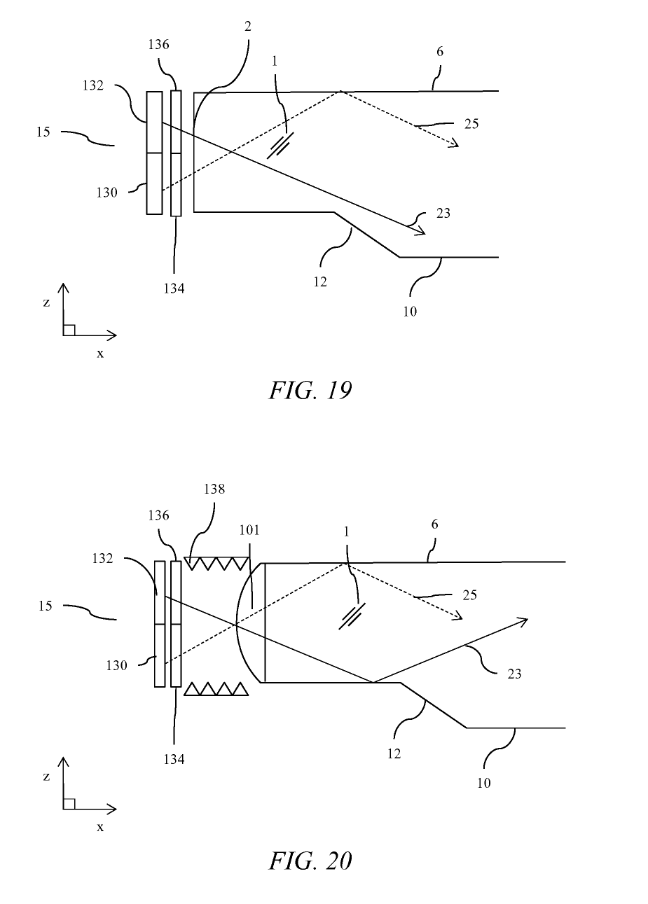

FIG. 19 is a schematic diagram in side view illustrating a further arrangement of optical valve and light emitting element array 15. The light emitting elements may comprise upper and lower emitting regions 132, 130 that are independently addressable. Region 130 may be approximately aligned with a polarizer 134 and region 132 may be approximately aligned with polarizer 136. Light rays 23 are thus produced by region 132 and light rays 25 are produced by regions 130. Advantageously, such an embodiment may reduce cost compared to a switching shutter array 128 of FIG. 18.

FIG. 20 is a schematic diagram in side view illustrating a further arrangement of optical valve and light emitting element array 15, wherein the optical valve comprises a further input focusing optic 101 arranged to direct light into viewing windows. A light baffle 138 may also be provided to reduce stray light in the system. In this embodiment, light rays 23, 25 overlap within the optical valve 1 due to reflections at side 6 and features 10. Advantageously, the present embodiment may be used to achieve a two dimensional array of polarized viewing windows, so that the vertical viewing freedom may be increased. Thus, the appearance of the parallax error between the retarders 104, 106 and pixels 105, 107 may be compensated for by adjusting the output polarization with vertical viewing angle, in cooperation with an observer tracking system.

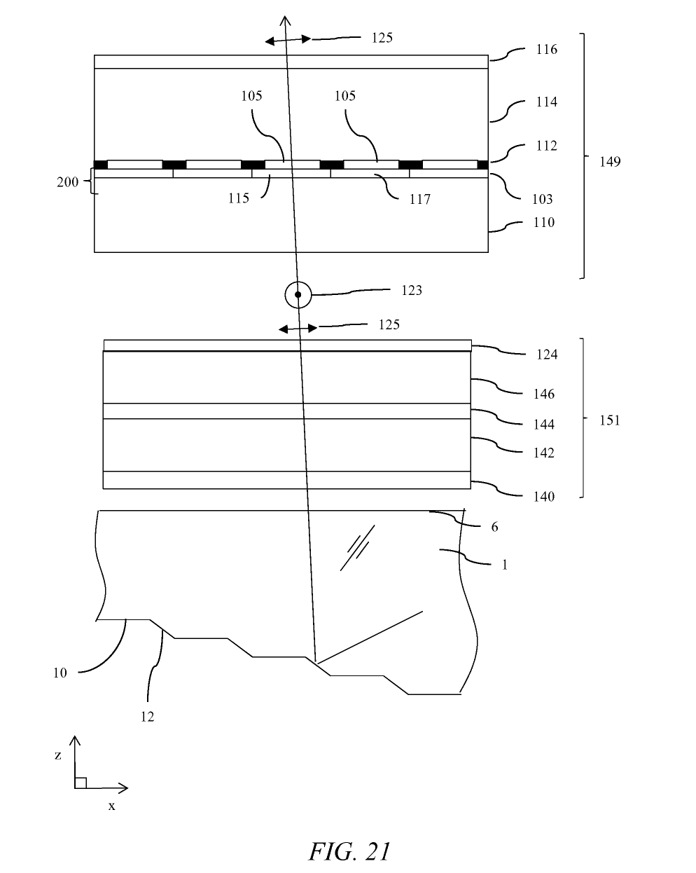

FIG. 21 is a schematic diagram in side view illustrating a further arrangement of optical valve and spatial light modulator 149. Propagation of polarized light within the valve may result in depolarization due to skew ray depolarization and scatter effects for example. It may thus be desirable for un-polarized light to propagate within the valve and to polarize the output of the valve in synchronisation with illumination of the appropriate light emitting element groups 50, 52 (light emitting element groups 50, 52 are shown in FIG. 18 and not shown in FIG. 21). Thus, a switchable polarizer 151 may comprise a polarizer 140, a substrate 142, switchable liquid crystal layer 144, substrate 146 and optional retarder 124 (which may alternatively be arranged on the SLM 149). During illumination of group 50, the switchable polarizer 151 may be arranged with a first output polarization state 123, and during illumination of group 52, the switchable polarizer may be switched to achieve a second output polarization state 125 incident onto the SLM 149. The light from the first guide surface 6 is provided with first and second polarisation directions by a time sequential polariser element 151 arranged between the first guide surface 6 and the direction splitting optical element comprising patterned polarizer array in layer 103. As previously discussed, light with the state 123 is directed to viewing window 26 with image data from pixels 105 and light with the state 125 is directed to viewing window 27 with image data from pixels 107 (viewing windows 26 and 27 are not shown in FIG. 21). The first and second polarisers may thus comprise a polariser layer 103 with an array of alternating regions of polariser 115, 117.

Advantageously the present embodiment may achieve a spatially multiplexed display from an un-polarized valve backlight, and thus may improve display uniformity and cross talk.

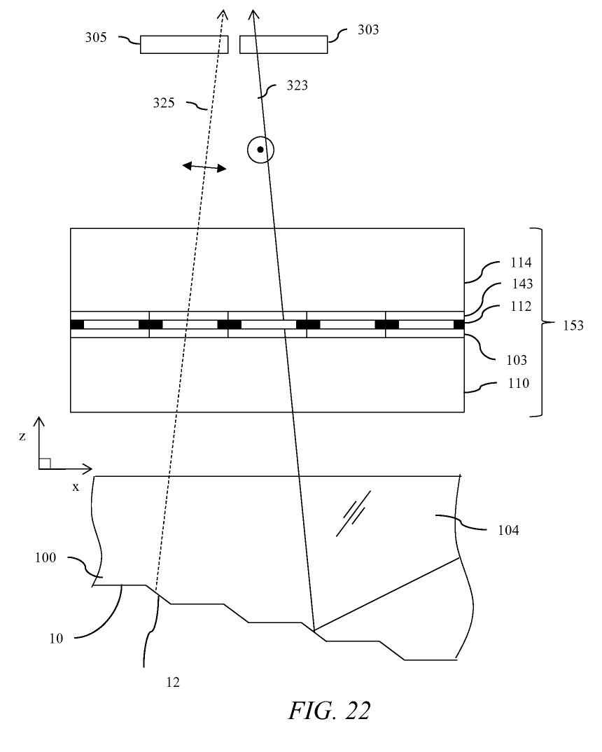

FIG. 22 is a schematic diagram in side view illustrating a further arrangement of optical valve and spatial light modulator 153. The SLM 153 is similar to SLM 149, except that the output polarizer 116 is replaced by an array 143 of patterned polarizer 143, that may be wire grid polarizers, for example, that have orthogonal output polarization states. The output of the display may operate as an autostereoscopic display as discussed previously. Autostereoscopic displays, particularly tracked autostereoscopic displays may have limited viewing freedom. It may be desirable to present a 3D image over a wider viewing angle to multiple observers. Such images can be achieved by stereoscopic display wherein an observer wears polarized spectacles comprising first and second mutually orthogonal polarizers 303, 305. Thus, if several groups of light emitting elements are switched on together, the spatial light modulator will be visible from a range of angles, with 3D images visible by means of stereoscopic viewing. In this manner, multiple observers may advantageously see a 3D image over a wide viewing angle.

The embodiments described show an optical valve as one example of a folded imaging directional backlight. Other embodiments may comprise an optical inline directional backlight, or wedge directional backlight. Each backlight may be arranged (for example, using the switchable polarizer 151 of FIG. 21) to achieving an array of viewing windows that may be polarized with different polarization states that are typically orthogonal.

Embodiments described above achieve spatial multiplexing by means of polarized output in the optical valve and patterned arrays of polarization analyzing elements to achieve spatial discrimination to light directed at respective viewing windows 26, 27. Polarization control in waveguides may be difficult due to skew ray depolarization and scatter for example. It may be desirable to achieve spatial multiplexing without polarization discrimination between the respective views.

FIG. 23 is a schematic diagram in side view illustrating a spatially multiplexed autostereoscopic display comprising a folded imaging directional backlight. The optical valve 1 is arranged to output a single viewing window 26 for a given group 54 of light emitting elements in the array 15, thus ray 221 is directed into a single position for all polarization states. A direction splitting optical element 200 is arranged on the input of the SLM 248.

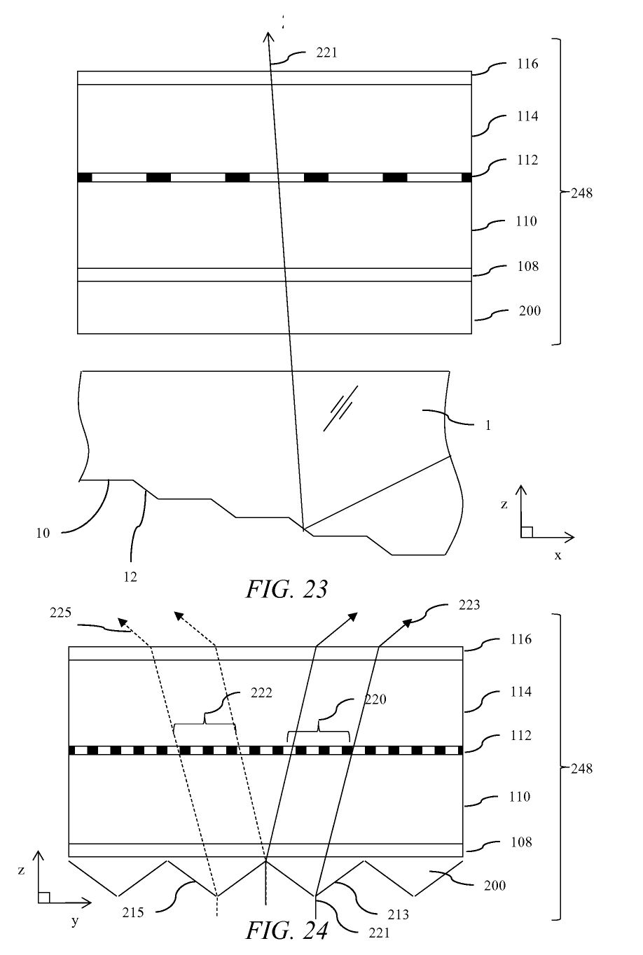

FIG. 24 is a schematic diagram in top view illustrating the spatial light modulator 248 of FIG. 23. Element 200 comprises an array of light redirecting elements 213, 215 that may comprise prisms, for example. Thus, input rays 221 that would be directed at a single window 26 may be directed into two different directions 223, 225 by respective elements 213, 215. The direction splitting optical element 200 thus comprises first and second prism array structures 213, 215 which may be arranged as alternating regions. Thus, rays 223 when viewed from a first viewing window 226 may comprise information from pixels 220; and rays 225 when viewed from a second viewing window 227 may comprise information from pixels 222. Thus, the SLM 248 may be spatially multiplexed with left and right eye image data, in correspondence with observer position.

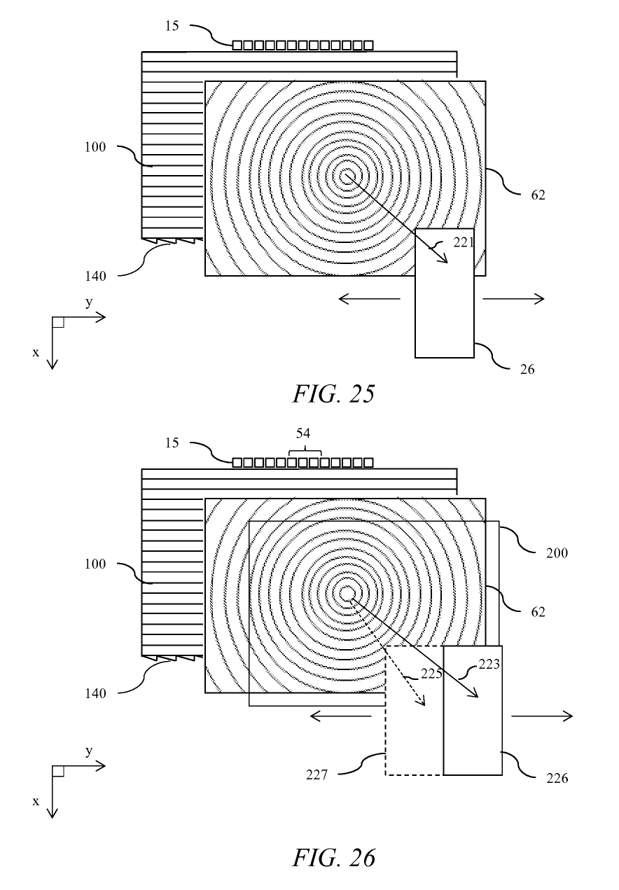

FIG. 25 is a schematic diagram in plan view illustrating the formation of viewing window 26 by means of rays 221 from a group 54 of light emitting elements.

FIG. 26 is a schematic diagram in plan view illustrating the formation of viewing windows 226, 227 by means of rays 223, 225, respectively, from the group 54 of light emitting elements, by means of the direction splitting optical element 200.

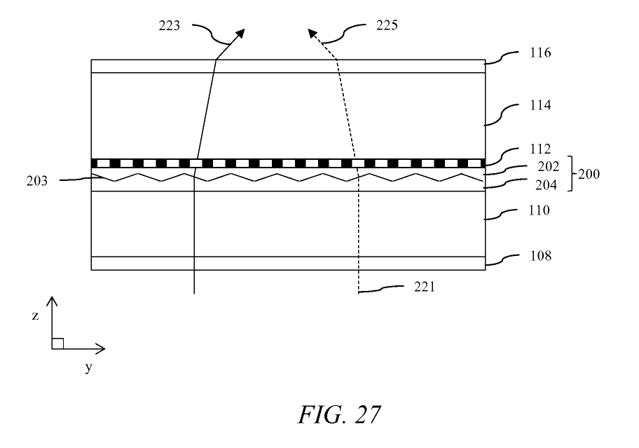

The embodiment described above advantageously achieves direction splitting with an external optical element 200; however, the separation of the pixels 112 from the splitting element 200 may create parallax errors and mixing of view data. FIG. 27 is a schematic diagram in top view of an alternative spatial light modulator 248 for use in the arrangement of FIGS. 23 and 25. The element 200 may comprise first and second layers 202, 204 made from materials with dissimilar refractive indices with a prismatic interface 203 therebetween. Advantageously, the present embodiment achieves approximate alignment between the prisms and pixels 112, thus the cross talk is reduced and the lateral viewing freedom is increased.

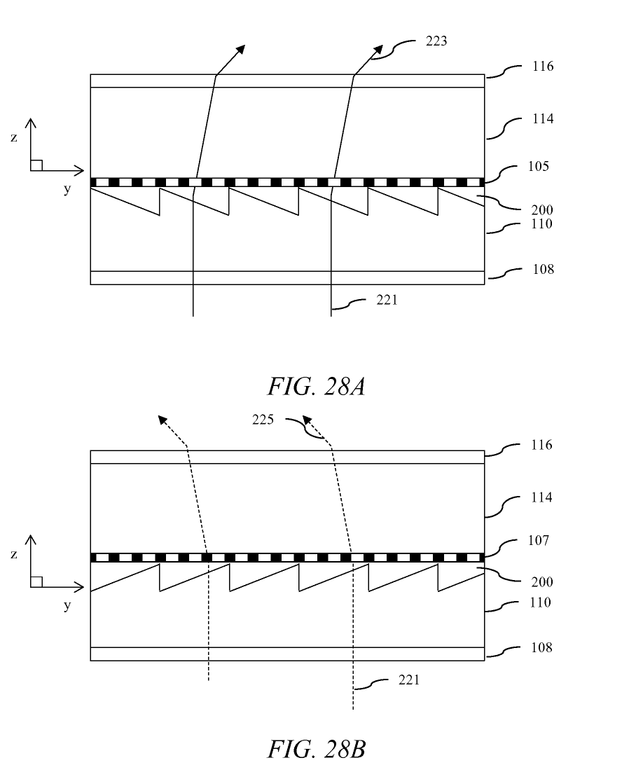

FIG. 28A is a schematic diagram in top view illustrating an alternative arrangement of prisms on a first set of rows 105 of image pixels 112 of the SLM 248. FIG. 28B is a schematic diagram in top view illustrating the arrangement of prisms on a second set of rows 107 of image pixels 112 of the SLM 248. Advantageously, the image data is spatially multiplexed in rows, reducing the cross talk between the respective views and the vertical viewing freedom may be increased.

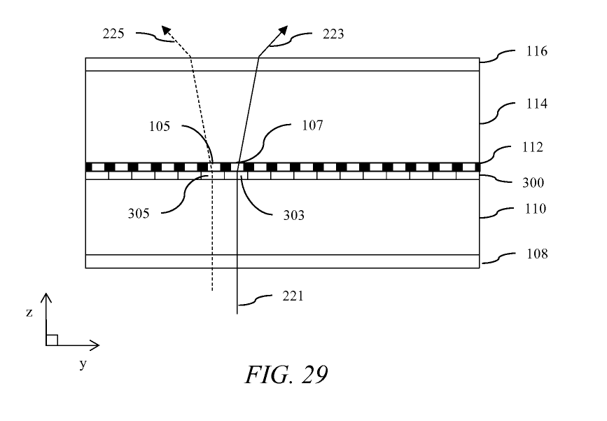

FIG. 29 is a schematic diagram in top view illustrating an alternative arrangement of the SLM 248 of FIG. 27 wherein the prismatic direction splitting optical element 200 is replaced by a diffractive direction splitting optical element 300. Element 300 may comprise regions 303 that deflect light rays 221 into directions 223 and also regions 305 that deflect light rays 221 into directions 225, thus forming viewing windows 226, 227, respectively (viewing windows 226, 227 not shown). The diffractive elements may be holographic and may be tuned to the spectral transmission of the respective colored pixel 112.

As may be used herein, the terms “substantially” and “approximately” provide an industry-accepted tolerance for its corresponding term and/or relativity between items. Such an industry-accepted tolerance ranges from less than one percent to ten percent and corresponds to, but is not limited to, component values, angles, et cetera. Such relativity between items ranges between less than approximately one percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A directional backlight comprising:
a waveguide having an input end; and
an array of light sources disposed at different input positions in a lateral direction across the input end of the waveguide,
the waveguide further comprising first and second, opposed guide surfaces for guiding light along the waveguide, and a reflective end facing the input end for reflecting input light from the input sources back through the waveguide, the waveguide being arranged to direct input light from the light sources as output light through the first guide surface after reflection from the reflective end into optical windows in output directions distributed in a lateral direction to the normal to the first guide surface that are dependent on the input positions,
a direction splitting optical element arranged to receive light from the first guide surface and direct said light into at least two separate optical windows.

2. A directional backlight according to claim 1, wherein the direction splitting optical element comprises first and second polarisers and the light from the first guide surface is provided with first and second polarisation directions.

3. A directional backlight according to claim 2, wherein the first and second polarisers comprises a polariser layer with an array of alternating regions of different polarisation absorption direction.

4. A directional backlight according to claim 2, wherein the first and second polarisers comprise a uniform polariser and a retarder layer with an array of alternating regions of optical axis direction and.

5. A directional backlight according to claim 2, wherein the light from the first guide surface is provided with first and second polarisation directions by a polariser element arranged between the light sources and the input end of the waveguide.

6. A directional backlight according to claim 2, wherein the light from the first guide surface is provided with first and second polarisation directions by a time sequential polariser element arranged between the first guide surface and the direction splitting optical element.

7. A directional backlight according to claim 6, wherein the first and second polarisation directions are orthogonal.

8. A directional backlight according to claim 1, wherein the direction splitting optical element comprises first and second light deflection structures.

9. A directional backlight according to claim 8, wherein the light deflection structures are prism array structures.

10. A directional backlight according to claim 8, wherein the light deflection structures are arranged as alternating regions

11. A directional backlight apparatus according to claim 1, wherein the first guide surface is arranged to guide light by total internal reflection and the second guide surface comprises a plurality of light extraction features oriented to reflect light guided through the waveguide in directions allowing exit through the first guide surface as the output light and intermediate regions between the light extraction features that are arranged to direct light through the waveguide without extracting it.

12. A directional backlight apparatus according to claim 11, wherein the second guide surface has a stepped shape comprising facets, that are said light extraction features, and the intermediate regions.

13. A directional backlight apparatus according to claim 1, wherein
the first guide surface is arranged to guide light by total internal reflection and the second guide surface is substantially planar and inclined at an angle to reflect light in directions that break the total internal reflection for outputting light through the first guide surface, and
the display device further comprises a deflection element extending across the first guide surface of the waveguide for deflecting light towards the normal to the spatial light modulator.

14. A directional backlight according to claim 1, wherein the reflective end has positive optical power in a lateral direction across the waveguide.

15. A display device comprising:
a directional backlight comprising:
a waveguide having an input end; and
an array of light sources disposed at different input positions in a lateral direction across the input end of the waveguide,
the waveguide further comprising first and second, opposed guide surfaces for guiding light along the waveguide, and a reflective end facing the input end for reflecting input light from the input sources back through the waveguide, the waveguide being arranged to direct input light from the light sources as output light through the first guide surface after reflection from the reflective end into optical windows in output directions distributed in a lateral direction to the normal to the first guide surface that are dependent on the input positions,
a direction splitting optical element arranged to receive light from the first guide surface and direct said light into at least two separate optical windows; and
a transmissive spatial light modulator arranged to receive the output light from the first guide surface and to modulate it to display an image.

16. A display device according to claim 15, wherein
the direction splitting optical elements are arranged in an array with first and second orientations;
the pixels of the spatial light modulator are aligned in an array;
the arrays of direction splitting optical elements and pixels are aligned.

17. A display apparatus comprising:
a display device comprising
a directional backlight comprising:
a waveguide having an input end; and
an array of light sources disposed at different input positions in a lateral direction across the input end of the waveguide,
the waveguide further comprising first and second, opposed guide surfaces for guiding light along the waveguide, and a reflective end facing the input end for reflecting input light from the input sources back through the waveguide, the waveguide being arranged to direct input light from the light sources as output light through the first guide surface after reflection from the reflective end into optical windows in output directions distributed in a lateral direction to the normal to the first guide surface that are dependent on the input positions,
a direction splitting optical element arranged to receive light from the first guide surface and direct said light into at least two separate optical windows; and
a transmissive spatial light modulator arranged to receive the output light from the first guide surface and to modulate it to display an image; and
a control system arranged to selectively operate the light sources to direct light into varying optical windows corresponding to said output directions.

18. A display apparatus according to claim 17, being an autostereoscopic display apparatus wherein the control system is further arranged to control the display device to display spatially multiplexed left and right images and to direct the displayed images into viewing windows in positions corresponding to left and right eyes of an observer.

19. A display apparatus according to claim 18, wherein
the control system of the autostereoscopic display apparatus further comprises a sensor system arranged to detect the position of an observer across the display device, and
the control system is arranged to selectively operate the light sources to direct the displayed left and right images into viewing windows in positions corresponding to left and right eyes of an observer being performed in dependence on the detected position of the observer.
